(19) United States
(12) Patent Application Publication
(10) Pub. No.: US 2026/0298710 A1
(43) Pub. Date: Oct. 1, 2026

(54) SPECTROMETRY DEVICE, AND SPECTROMETRY METHOD

(71) Applicant: HAMAMATSU PHOTONICS K.K., Hamamatsu-shi, Shizuoka (JP)

(72) Inventors: Kenichi OHTSUKA, Hamamatsu-shi, Shizuoka (JP); Kiyotada HOSOKAWA, Hamamatsu-shi, Shizuoka (JP); Hideki MASUOKA, Hamamatsu-shi, Shizuoka (JP); Teruo TAKAHASHI, Hamamatsu-shi, Shizuoka (JP)

(73) Assignee: HAMAMATSU PHOTONICS K.K., Hamamatsu-shi, Shizuoka (JP)

(21) Appl. No.: 18/881,824

(22) PCT Filed: Jul. 12, 2023
(86) PCT No.: PCT/JP2023/025769

§ 371 Date: Jan. 7, 2025

(30) Foreign Application Priority Data
Sep. 6, 2022 (JP) 2022-141395

(51) Int. Cl. G01J 3/28; G01J 3/02

(52) U.S. Cl. CPC G01J 3/2823; G01J 3/0218; G01J 3/0232; G01J 3/0262; G01J 3/0297; G01J 3/18; G01J 3/2803; G01J 3/36; G01J 2003/2866

(57) ABSTRACT

In a spectrometry device, an analysis unit corrects a first electric signal using a first correction coefficient to make a linearity characteristic of a first amplifier match with a reference linearity characteristic. The analysis unit corrects a second electric signal using a second correction coefficient to make a linearity characteristic of a second amplifier match with the reference linearity characteristic. The analysis unit generates first spectrum data based on the corrected first electric signal, and generates second spectrum data based on the corrected second electric signal. The analysis unit generates spectrum data of measurement target light based on the first spectrum data and the second spectrum data.

### TECHNICAL FIELD

The present disclosure relates to a spectrometry device and a spectrometry method.

### BACKGROUND ART

There is known a spectrometry device including: an optical system that disperses measurement target light; a photodetector that receives a spectral image of the dispersed measurement target light in a first region with a short exposure time and in a second region with a long exposure time; and an analysis unit that generates spectrum data of the measurement target light based on first spectrum data generated based on a detection result in the first region and second spectrum data generated based on a detection result in the second region (see, for example, Patent Literature 1). According to such a spectrometry device, it is possible to generate the spectrum data of the measurement target light in a wide dynamic range.

### CITATION LIST

### Patent Literature

Patent Literature 1: Japanese Unexamined Patent Publication No. 2020-118477

### SUMMARY OF INVENTION

### Technical Problem

In the spectrometry device as described above, an error due to a factor other than a difference in the exposure time may occur between the first spectrum data and the second spectrum data. If the spectrum data of the measurement target light is generated based on the first spectrum data and the second spectrum data in a state in which such an error occurs, the accuracy of the spectrum data of the measurement target light may be deteriorated.

An object of the present disclosure is to provide a spectrometry device and a spectrometry method capable of acquiring highly accurate spectrum data of measurement target light.

### Solution to Problem

A spectrometry device according to one aspect of the present disclosure is [1] “a spectrometry device including: an optical system configured to disperse measurement target light; a photodetector configured to detect a spectral image of the measurement target light dispersed by the optical system; and an analysis unit configured to generate spectrum data of the measurement target light, wherein the photodetector includes: a first light receiving unit including a plurality of first pixel columns arrayed in a horizontal direction parallel to a wavelength axis of the spectral image, each of the plurality of first pixel columns including a plurality of first pixels arrayed in a vertical direction perpendicular to the wavelength axis; a second light receiving unit juxtaposing with the first light receiving unit in the vertical direction and includes a plurality of second pixel columns arrayed in the horizontal direction, each of the plurality of second pixel columns including a plurality of second pixels arrayed in the vertical direction; a first vertical transfer unit configured to transfer a first charge accumulated in each of the plurality of first pixels by receiving the spectral image for a first exposure time in the first light receiving unit, for each of the plurality of first pixel columns in the vertical direction; a first horizontal transfer unit configured to transfer the first charge transferred by the first vertical transfer unit in the horizontal direction; a first amplifier configured to output a first electric signal corresponding to an amount of the first charge transferred by the first horizontal transfer unit; a second vertical transfer unit configured to transfer a second charge accumulated in each of the plurality of second pixels by receiving the spectral image for a second exposure time longer than the first exposure time in the second light receiving unit, for each of the plurality of second pixel columns in the vertical direction; a second horizontal transfer unit configured to transfer the second charge transferred by the second vertical transfer unit in the horizontal direction; and a second amplifier configured to output a second electric signal corresponding to an amount of the second charge transferred by the second horizontal transfer unit, and the analysis unit stores a first correction coefficient for correcting the first electric signal to make a linearity characteristic of the first amplifier match with a reference linearity characteristic, stores a second correction coefficient for correcting the second electric signal to make a linearity characteristic of the second amplifier match with the reference linearity characteristic, corrects the first electric signal using the first correction coefficient, corrects the second electric signal using the second correction coefficient, generates first spectrum data based on the corrected first electric signal, generates second spectrum data based on the corrected second electric signal, and generates the spectrum data of the measurement target light based on the first spectrum data and the second spectrum data”.

In the spectrometry device according to [1], the photodetector receives the spectral image for the first exposure time in the first light receiving unit and outputs the first electric signal, and receives the spectral image for the second exposure time longer than the first exposure time in the second light receiving unit and outputs the second electric signal, and the analysis unit generates the first spectrum data based on the first electric signal and generates the second spectrum data based on the second electric signal. Then, the analysis unit generates the spectrum data of the measurement target light based on the first spectrum data and the second spectrum data. Thus, the spectrum data of the measurement target light can be generated in a wide dynamic range. Furthermore, in the spectrometry device according to [1], the analysis unit corrects the first electric signal using the first correction coefficient and corrects the second electric signal using the second correction coefficient. As a result, it is possible to correct an error generated in each of the linearity characteristic of the first amplifier and the linearity characteristic of the second amplifier. Therefore, the spectrometry device according to [1] can acquire the spectrum data of the measurement target light with high accuracy.

The spectrometry device according to one aspect of the present disclosure may be [2] “the spectrometry device according to [1], wherein the analysis unit generates the first spectrum data based on a first correspondence relationship between each of the plurality of first pixel columns and a wavelength on the wavelength axis, and generates the second spectrum data based on a second correspondence relationship between each of the plurality of second pixel columns and the wavelength on the wavelength axis”. In the spectrometry device, there may be a deviation between a position of the first pixel column on which an optical image of a certain wavelength of the spectral image is formed and a position of the second pixel column on which the optical image is formed. With the spectrometry device according to [2], even when such a positional deviation occurs, it is possible to acquire the first spectrum data and the second spectrum data in which such a positional deviation is corrected.

The spectrometry device according to one aspect of the present disclosure may be [3] “the spectrometry device according to [1] or [2], wherein the analysis unit corrects at least one of the first spectrum data and the second spectrum data based on a ratio between a representative value of an intensity of the first spectrum data and a representative value of an intensity of the second spectrum data”. In the spectrometry device, there may be a difference between a light intensity in the first pixel column on which an optical image of a certain wavelength of the spectral image is formed and a light intensity in the second pixel column on which the optical image is formed. With the spectrometry device according to [3], even when such a difference in the light intensity occurs, it is possible to acquire the first spectrum data and the second spectrum data in which such a difference in the light intensity is corrected.

The spectrometry device according to one aspect of the present disclosure may be [4] “the spectrometry device according to any one of [1] to [3], wherein the analysis unit performs correction on the second spectrum data to remove stray light generated in the optical system”. When focusing only on noise generated on a circuit, S/N of the second spectrum data is higher than S/N of the first spectrum data. However, there is a case where the measurement target light includes the stray light, and in this case, noise caused by the stray light increases as the second exposure time is longer than the first exposure time, and the S/N of the second spectrum data decreases. With the spectrometry device according to [4], even when the measurement target light includes the stray light, it is possible to acquire the second spectrum data from which such stray light has been removed.

The spectrometry device according to one aspect of the present disclosure may be [5] “the spectrometry device according to any one of [1] to [4], further including a fiber bundle including a plurality of optical fibers guiding the measurement target light to the optical system and having an incident end face having a circular shape and an emitting end face having an elongated shape, wherein the plurality of optical fibers include a plurality of first optical fibers disposed on one side with respect to a center of the emitting end face in the emitting end face and a plurality of second optical fibers disposed on another side with respect to the center of the emitting end face in the emitting end face, and each of the plurality of first optical fibers and each of the plurality of second optical fibers are adjacent to each other in at least one of a circumferential direction and a radial direction on the incident end face”. In the spectrometry device according to [5], even when the light intensity of the measurement target light is biased on the incident end face of the fiber bundle, the bias of the light intensity of the measurement target light is suppressed in the emitting end face of the fiber bundle. Therefore, with the spectrometry device according to [5], when focusing on the first pixel column and the second pixel column on which the optical image of the certain wavelength of the spectral image is formed, it is possible to acquire the first spectrum data and the second spectrum data while suppressing the occurrence of the difference between the light intensity in the first pixel column and the light intensity in the second pixel column.

The spectrometry device according to one aspect of the present disclosure may be [6] “the spectrometry device according to any one of [1] to [5], further including: a fiber bundle including a plurality of optical fibers guiding the measurement target light to the optical system; and a light diffusion unit disposed at a preceding stage of the fiber bundle and configured to diffuse and guide the measurement target light to an incident end face of the fiber bundle”. In the spectrometry device according to [6], the measurement target light diffused by the light diffusion unit is incident on the incident end face of the fiber bundle, and thus, the bias of the light intensity of the measurement target light is suppressed on the incident end face of the fiber bundle. Therefore, with the spectrometry device according to [6], when focusing on the first pixel column and the second pixel column on which the optical image of the certain wavelength of the spectral image α is formed, it is possible to acquire the first spectrum data and the second spectrum data while suppressing the occurrence of the difference between the light intensity in the first pixel column and the light intensity in the second pixel column.

The spectrometry device according to one aspect of the present disclosure may be [7] “the spectrometry device according to any one of [1] to [6], wherein the photodetector has an electronic shutter function to discharge the first charge accumulated in each of the plurality of first pixels over a predetermined time from a start of one frame time between a start of transfer of the first charge by the first vertical transfer unit to an end of transfer of the first charge by the first horizontal transfer unit, and the electronic shutter function to set a time excluding the predetermined time in the one frame time as the first exposure time, and the analysis unit stores a third correction coefficient for correcting the first electric signal to make the linearity characteristic of the first amplifier match with the reference linearity characteristic in association with the predetermined time when the electronic shutter function is used, and corrects the first electric signal using the third correction coefficient”. When the electronic shutter function is used for the first light receiving unit, the intensity of the first electric signal decreases as a length of the predetermined time increases, but strictly, the intensity of the first electric signal does not linearly decrease. With the spectrometry device according to [7], the first spectrum data in which the error generated in the linearity characteristic of the first amplifier is corrected can be acquired by using the third correction coefficient associated with the predetermined time to correct the first electric signal.

The spectrometry device according to one aspect of the present disclosure may be [8] “the spectrometry device according to [2], wherein the photodetector has an electronic shutter function to discharge the first charge accumulated in each of the plurality of first pixels over a predetermined time from a start of one frame time between a start of transfer of the first charge by the first vertical transfer unit to an end of transfer of the first charge by the first horizontal transfer unit, and the electronic shutter function to set a time excluding the predetermined time in the one frame time as the first exposure time, and the analysis unit generates the first spectrum data based on the first correspondence relationship corresponding to at least one of the predetermined time and the first exposure time”. When the electronic shutter function is used for the first light receiving unit, there may be a deviation in the correspondence relationship between each of the plurality of first pixel columns and the wavelength on the wavelength axis. With the spectrometry device according to [8], it is possible to acquire the first spectrum data in which the deviation in the correspondence relationship is corrected by generating the first spectrum data based on the first correspondence relationship corresponding to at least one of the predetermined time and the first exposure time.

The spectrometry device according to one aspect of the present disclosure may be [9] “the spectrometry device according to any one of [1] to [6], wherein the photodetector has an electronic shutter function to discharge the first charge accumulated in each of the plurality of first pixels over a predetermined time from a start of one frame time between a start of transfer of the first charge by the first vertical transfer unit to an end of transfer of the first charge by the first horizontal transfer unit, and the electronic shutter function to set a time excluding the predetermined time in the one frame time as the first exposure time”. With the spectrometry device according to [9], by using the electronic shutter function for the first light receiving unit, it is possible to prevent each of the first pixels from being saturated in the first light receiving unit and to reliably acquire the first spectrum data in a saturation wavelength band.

The spectrometry device according to one aspect of the present disclosure may be [10] “the spectrometry device according to any one of [1] to [9], wherein the analysis unit generates a first function of the first spectrum data and a second function of the second spectrum data when the first light receiving unit and the second light receiving unit are exposed for an identical exposure time, and corrects at least one of the first spectrum data and the second spectrum data based on a ratio between the first function and the second function”. In the spectrometry device, the light receiving sensitivity of the first light receiving unit and the light receiving sensitivity of the second light receiving unit do not always match. With the spectrometry device described in [10], even when a deviation between light receiving sensitivities occurs, it is possible to acquire the first spectrum data and the second spectrum data in which the deviation between the light receiving sensitivities is corrected.

The spectrometry device according to one aspect of the present disclosure may be [11] “the spectrometry device according to any one of [1] to [10], wherein the analysis unit corrects at least one of the first spectrum data and the second spectrum data based on a ratio between the first exposure time and the second exposure time”. With the spectrometry device according to [11], it is possible to acquire the first spectrum data and the second spectrum data in which influence on the light intensity due to a difference in the exposure time is corrected.

A spectrometry device according to one aspect of the present disclosure is [12] “a spectrometry device including: an optical system configured to disperse measurement target light; a photodetector configured to detect a spectral image of the measurement target light dispersed by the optical system; and a storage unit, wherein the photodetector includes: a first light receiving unit including a plurality of first pixel columns arrayed in a horizontal direction parallel to a wavelength axis of the spectral image, each of the plurality of first pixel columns including a plurality of first pixels arrayed in a vertical direction perpendicular to the wavelength axis; a second light receiving unit juxtaposing with the first light receiving unit in the vertical direction and includes a plurality of second pixel columns arrayed in the horizontal direction, each of the plurality of second pixel columns including a plurality of second pixels arrayed in the vertical direction; a first vertical transfer unit configured to transfer a first charge accumulated in each of the plurality of first pixels by receiving the spectral image for a first exposure time in the first light receiving unit, for each of the plurality of first pixel columns in the vertical direction; a first horizontal transfer unit configured to transfer the first charge transferred by the first vertical transfer unit in the horizontal direction; a first amplifier configured to output a first electric signal corresponding to an amount of the first charge transferred by the first horizontal transfer unit; a second vertical transfer unit configured to transfer a second charge accumulated in each of the plurality of second pixels by receiving the spectral image for a second exposure time longer than the first exposure time in the second light receiving unit, for each of the plurality of second pixel columns in the vertical direction; a second horizontal transfer unit configured to transfer the second charge transferred by the second vertical transfer unit in the horizontal direction; and a second amplifier configured to output a second electric signal corresponding to an amount of the second charge transferred by the second horizontal transfer unit, and the storage unit stores a first correction coefficient for correcting the first electric signal to make a linearity characteristic of the first amplifier match with a reference linearity characteristic, and stores a second correction coefficient for correcting the second electric signal to make a linearity characteristic of the second amplifier match with the reference linearity characteristic”.

In the spectrometry device according to [12], the photodetector receives the spectral image for the first exposure time in the first light receiving unit and outputs the first electric signal, and receives the spectral image for the second exposure time longer than the first exposure time in the second light receiving unit and outputs the second electric signal. The storage unit stores the first correction coefficient for correcting the first electric signal and the second correction coefficient for correcting the second electric signal. Therefore, when the spectrum data of the measurement target light is generated based on the first electric signal and the second electric signal, an error generated in each of the linearity characteristic of the first amplifier and the linearity characteristic of the second amplifier can be corrected by correcting the first electric signal using the first correction coefficient and correcting the second electric signal using the second correction coefficient. Therefore, the spectrometry device according to [12] can acquire the spectrum data of the measurement target light with high accuracy.

A spectrometry method according to one aspect of the present disclosure is [13] “a spectrometry method using a spectrometry device, the spectrometry device including: an optical system configured to disperse measurement target light; a photodetector configured to detect a spectral image of the measurement target light dispersed by the optical system; and an analysis unit configured to generate spectrum data of the measurement target light, the photodetector including: a first light receiving unit including a plurality of first pixel columns arrayed in a horizontal direction parallel to a wavelength axis of the spectral image, each of the plurality of first pixel columns including a plurality of first pixels arrayed in a vertical direction perpendicular to the wavelength axis; a second light receiving unit juxtaposing with the first light receiving unit in the vertical direction and includes a plurality of second pixel columns arrayed in the horizontal direction, each of the plurality of second pixel columns including a plurality of second pixels arrayed in the vertical direction; a first vertical transfer unit configured to transfer a first charge accumulated in each of the plurality of first pixels by receiving the spectral image for a first exposure time in the first light receiving unit, for each of the plurality of first pixel columns in the vertical direction; a first horizontal transfer unit configured to transfer the first charge transferred by the first vertical transfer unit in the horizontal direction; a first amplifier configured to output a first electric signal corresponding to an amount of the first charge transferred by the first horizontal transfer unit; a second vertical transfer unit configured to transfer a second charge accumulated in each of the plurality of second pixels by receiving the spectral image for a second exposure time longer than the first exposure time in the second light receiving unit, for each of the plurality of second pixel columns in the vertical direction; a second horizontal transfer unit configured to transfer the second charge transferred by the second vertical transfer unit in the horizontal direction; and a second amplifier that outputs a second electric signal corresponding to an amount of the second charge transferred by the second horizontal transfer unit, the spectrometry method including: a step of correcting the first electric signal to make a linearity characteristic of the first amplifier match with a reference linearity characteristic and correcting the second electric signal to make a linearity characteristic of the second amplifier match with the reference linearity characteristic; a step of generating first spectrum data based on the corrected first electric signal and generating second spectrum data based on the corrected second electric signal; and a step of generating the spectrum data of the measurement target light based on the first spectrum data and the second spectrum data”.

According to the spectrometry method described in [13], it is possible to acquire highly accurate spectrum data of the measurement target light for the same reason as that in the spectrometry device described in [1].

### Advantageous Effects of Invention

According to the present disclosure, it is possible to provide the spectrometry device and the spectrometry method capable of acquiring the highly accurate spectrum data of the measurement target light.

### BRIEF DESCRIPTION OF DRAWINGS

FIG. 1 is a diagram illustrating a configuration of a spectrometry device according to an embodiment.

FIG. 2 is a diagram illustrating configurations of an incident end face and an emitting end face of a fiber bundle illustrated in FIG. 1.

FIG. 3 is a diagram illustrating a configuration of a photodetector illustrated in FIG. 1.

FIG. 4 is a view for describing an exposure timing of each of first pixels.

FIG. 5 is a view for describing the exposure timing of each of the first pixels.

FIG. 6 is a view for describing the exposure timing of each of the first pixels when an electronic shutter is used.

FIG. 7 is a view for describing the exposure timing of each of the first pixels when the electronic shutter is used.

FIG. 8 is a view for describing the exposure timing of each of the first pixels when the electronic shutter is used.

FIG. 9 is a view illustrating processing performed by an analysis unit.

FIG. 10 is a view illustrating linearity characteristics of a first amplifier and a second amplifier.

FIG. 11 is a view illustrating a correspondence relationship between a first exposure time and a first correction coefficient, and a correspondence relationship between a second exposure time and a second correction coefficient.

FIG. 12 is a view for describing wavelength axis correction.

FIG. 13 is a view illustrating a first correspondence relationship between a position of a first pixel column and a wavelength of a spectral image and a second correspondence relationship between a position of a second pixel column and the wavelength of the spectral image.

FIG. 14 is a view for describing generation of each of first spectrum data and second spectrum data.

FIG. 15 is a view for describing correction of input dependence.

FIG. 16 is a view for describing stray light correction.

FIG. 17 is a view for describing generation of spectrum data of measurement target light.

FIG. 18 is a view illustrating a relationship between a charge discarding time and an intensity of a first electric signal when the electronic shutter is used.

FIG. 19 is a view illustrating a correspondence relationship between the charge discarding time and a third correction coefficient.

FIG. 20 is a view illustrating the first correspondence relationship corrected based on the first exposure time.

FIG. 21 is a view for describing an anti-blooming function of the photodetector.

FIG. 22 is a view for describing a light diffusion unit.

### DESCRIPTION OF EMBODIMENTS

Hereinafter, an embodiment of the present disclosure will be described in detail with reference to the accompanying drawings. Note that, in the drawings, the same or corresponding parts are denoted by the same reference signs, and redundant description will be not be given.

### [Configuration of Spectrometry Device]

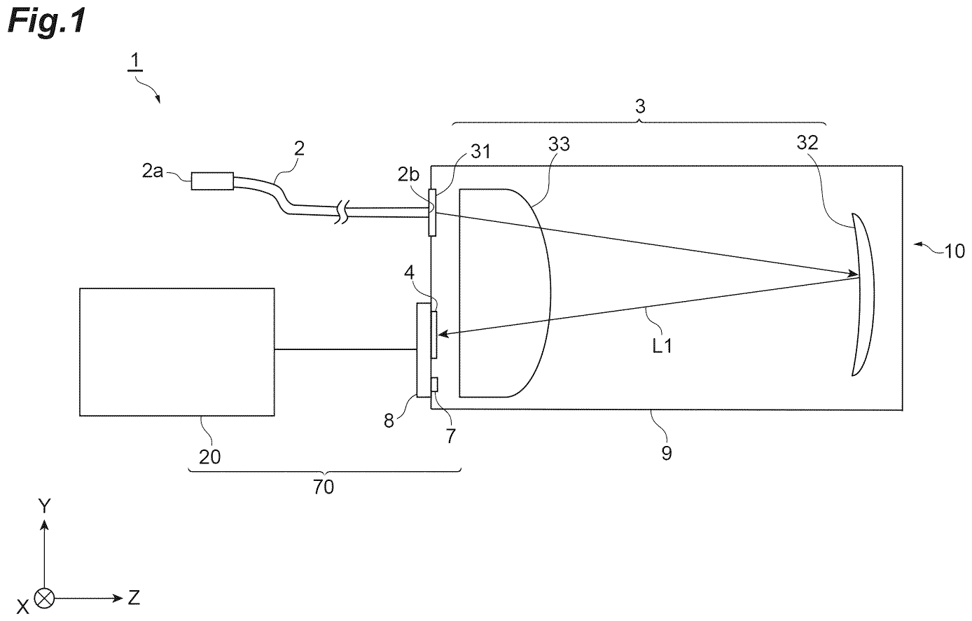

As illustrated in FIG. 1, a spectrometry device 1 includes a spectroscope 10 and a computer device 20. The computer device 20 is, for example, a personal computer, and includes a processing unit, a storage unit, a display unit, and an input unit. The processing unit includes a processor, a memory, a storage, a communication device, and the like, and executes software (a program) to process various types of data. The storage unit is a hard disk or the like, and stores various types of data. The display unit is a display or the like, and displays various types of data to an operator. The input unit is a mouse, a keyboard, or the like, and receives inputs of various types of data from the operator. The spectroscope 10 includes a fiber bundle 2, an optical system 3, a photodetector 4, a storage unit 7, a control board 8, and a housing 9. In the present embodiment, the storage unit 7, the control board 8, and the computer device 20 constitute an analysis unit 70 that generates spectrum data of measurement target light L1. The spectrometry device 1 generates the spectrum data of the measurement target light L1 by dispersing the measurement target light L1.

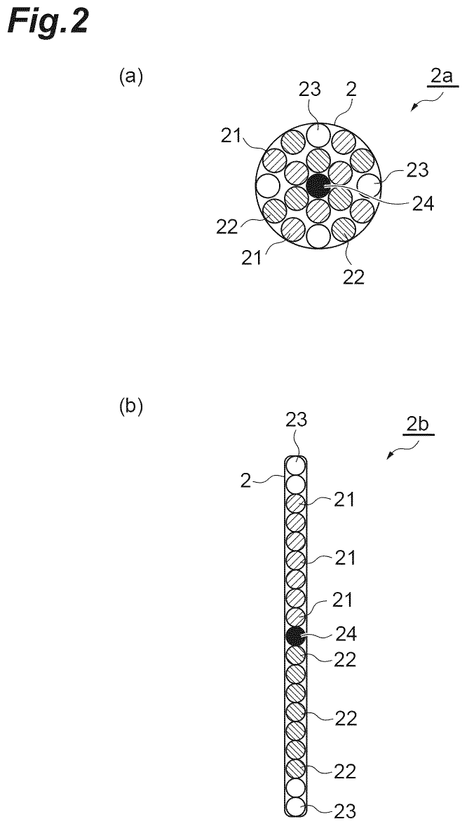

The fiber bundle 2 guides the measurement target light L1 to the optical system 3. The fiber bundle 2 has a circular incident end face 2a and an elongated emitting end face 2b. The fiber bundle 2 includes a plurality of optical fibers. As illustrated in (a) and (b) of FIG. 2, the fiber bundle 2 includes a plurality of first optical fibers 21, a plurality of second optical fibers 22, a plurality of third optical fibers 23, and a fourth optical fiber 24.

The incident end face 2a of the fiber bundle 2 has the following configuration. As illustrated in (a) of FIG. 2, the fourth optical fiber 24 is disposed at the center of the incident end face 2a. The plurality of third optical fibers 23 are arranged along an outer edge of the incident end face 2a. Each of the plurality of third optical fibers 23 is disposed at a predetermined interval. The plurality of first optical fibers 21 and the plurality of second optical fibers 22 are disposed between the fourth optical fiber 24 and the third optical fibers 23, and between each of the plurality of third optical fibers 23. Each of the plurality of first optical fibers 21 and each of the plurality of second optical fibers 22 are disposed so as to be adjacent to each other in the circumferential direction of the incident end face 2a. Each of the plurality of first optical fibers 21 and each of the plurality of second optical fibers 22 may be disposed so as to be adjacent to each other in the radial direction of the incident end face 2a.

The emitting end face 2b of the fiber bundle 2 has the following configuration. As illustrated in (b) of FIG. 2, the fourth optical fiber 24 is disposed at the center of the emitting end face 2b. The plurality of third optical fibers 23 are disposed at both ends of the emitting end face 2b. The plurality of first optical fibers 21 are disposed between the fourth optical fiber 24 and a plurality of the third optical fibers 23 disposed at one end of the emitting end face 2b. In other words, the plurality of first optical fibers 21 are disposed on one side with respect to the center of the emitting end face 2b. The plurality of second optical fibers 22 are disposed between the fourth optical fiber 24 and a plurality of the third optical fibers 23 disposed at the other end of the emitting end face 2b. In other words, the plurality of second optical fibers 22 are disposed on the other side with respect to the center of the emitting end face 2b.

As illustrated in FIG. 1, the optical system 3 includes a light incident portion 31, a diffraction grating 32, and a lens 33. The optical system 3 guides the measurement target light L1 to the photodetector 4 and forms a spectral image of the measurement target light L1 on a light receiving unit of the photodetector 4. In the present embodiment, the optical system 3 is a Dyson optical system. In addition, in the present embodiment, the diffraction grating 32 is a reflective diffraction grating. The measurement target light L1 is dispersed by the diffraction grating 32 in a direction perpendicular to a direction in which the measurement target light L1 is incident. Here, the direction in which the measurement target light L1 is dispersed is referred to as an X-axis direction, a direction perpendicular to the X-axis direction is referred to as a Y-axis direction, and a direction perpendicular to the X-axis direction and the Y-axis direction is referred to as a Z-axis direction.

The emitting end face 2b of the fiber bundle 2 is connected to the light incident portion 31. The emitting end face 2b of the fiber bundle 2 is connected to the light incident portion 31 with the Y-axis direction as the longitudinal direction when viewed from the Z-axis direction. The light incident portion 31 causes the measurement target light L1 guided from the fiber bundle 2 to enter the optical system 3. The light incident portion 31 adjusts the amount of entry of the measurement target light L1. The light incident portion 31 is, for example, a slit member. A slit formed in the slit member is opened in a rectangular shape having a short side in the X-axis direction and a long side in the Y-axis direction when viewed from the Z-axis direction.

The diffraction grating 32 opposes the light incident portion 31 in the Z-axis direction. The diffraction grating 32 includes a plurality of grating grooves (not illustrated). The plurality of grating grooves are arranged along the X-axis direction in a state in which each of the grating grooves extends along the Y-axis direction. The measurement target light L1 that has entered the diffraction grating 32 is dispersed according to wavelengths along the X-axis direction that is a direction in which the plurality of grating grooves are arranged.

The lens 33 is disposed between the light incident portion 31 and the diffraction grating 32 in the Z-axis direction. The lens 33 is disposed between the photodetector 4 and the diffraction grating 32 in the Z-axis direction. The lens 33 guides the measurement target light L1 incident from the light incident portion 31 to the diffraction grating 32, and forms the spectral image of the measurement target light L1 dispersed by the diffraction grating 32 on the light receiving unit of the photodetector 4.

The photodetector 4 opposes the diffraction grating 32 in the Z-axis direction. The photodetector 4 detects the measurement target light L1 dispersed by the diffraction grating 32. In the present embodiment, the photodetector 4 is a full-frame transfer type CCD image sensor.

The storage unit 7 and the photodetector 4 are mounted on the control board 8. The storage unit 7 stores correction coefficients for correcting data detected by the photodetector 4. The storage unit 7 is a storage medium such as a random access memory (RAM) or a read only memory (ROM). The computer device 20 is electrically connected to the control board 8. The computer device 20 acquires data from the photodetector 4, acquires the correction coefficients from the storage unit 7, corrects the data, and then generates spectrum data of the measurement target light L1.

The housing 9 accommodates the diffraction grating 32, the lens 33, the photodetector 4, and the storage unit 7. The light incident portion 31 and the control board 8 are attached to a wall portion of the housing 9.

### [Configuration and Operation of Photodetector]

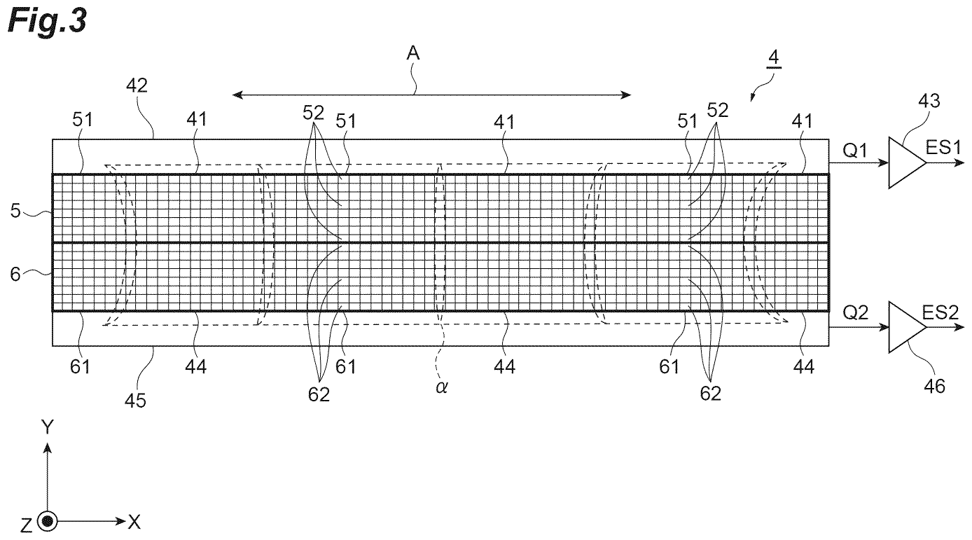

As illustrated in FIG. 3, the photodetector 4 includes a first light receiving unit 5 and a second light receiving unit 6. The first light receiving unit 5 and the second light receiving unit 6 are juxtaposed along the Y-axis direction. A wavelength axis A of a spectral image α formed on the first light receiving unit 5 and the second light receiving unit 6 extends in the X-axis direction. An image for each wavelength of the spectral image α extends in the Y-axis direction. The spectral image α preferably has a line-symmetric shape with respect to a boundary line between the first light receiving unit 5 and the second light receiving unit 6.

The first light receiving unit 5 includes a plurality of first pixel columns 51 arrayed in the X-axis direction. Each of the plurality of first pixel columns 51 includes a plurality of first pixels 52 arrayed in the Y-axis direction. The first light receiving unit 5 includes, for example, 2168 first pixel columns 51. Each of the plurality of first pixel columns 51 includes, for example, 128 first pixels 52. The second light receiving unit 6 includes a plurality of second pixel columns 61 arrayed in the X-axis direction. Each of the plurality of second pixel columns 61 includes a plurality of second pixels 62 arrayed in the Y-axis direction. The second light receiving unit 6 includes, for example, 2168 second pixel columns 61. Each of the plurality of second pixel columns 61 includes, for example, 128 second pixels 62. Each of the plurality of first pixels 52 receives the spectral image α for a first exposure time, thereby generating and accumulating an amount of a first charge Q1 corresponding to an intensity of the received spectral image α. Each of the plurality of second pixels 62 receives the spectral image α for a second exposure time to generate and accumulate an amount of a second charge Q2 corresponding to an intensity of the received spectral image α. The first exposure time is shorter than the second exposure time.

The photodetector 4 further includes a first vertical transfer unit 41, a first horizontal transfer unit 42, and a first amplifier 43. The first vertical transfer unit 41 transfers the first charge Q1 accumulated in each of the plurality of first pixels 52 in the Y-axis direction. Hereinafter, transferring in the Y-axis direction is referred to as “transferring in the vertical direction”. In the present embodiment, since the photodetector 4 is the full-frame transfer type CCD image sensor, the first vertical transfer unit 41 is not divided from each of the first pixel columns 51. In that case, the first vertical transfer unit 41 is a plurality of transfer electrodes (not illustrated) that transfer the first charge Q1 in the vertical direction along each of the first pixel columns 51. The first horizontal transfer unit 42 is adjacent to the first light receiving unit 5 on an opposite side of the second light receiving unit 6 and extends in the X-axis direction. The first horizontal transfer unit 42 transfers the first charge Q1, transferred from each of the first pixel columns 51 by the first vertical transfer unit 41, in the X-axis direction. Hereinafter, transferring in the X-axis direction is referred to as “transferring in the horizontal direction”.

The photodetector 4 further includes a second vertical transfer unit 44, a second horizontal transfer unit 45, and a second amplifier 46. The second vertical transfer unit 44 transfers the second charge Q2 accumulated in each of the plurality of second pixels 62 in the vertical direction. In the present embodiment, since the photodetector 4 is the full-frame transfer type CCD image sensor, the second vertical transfer unit 44 is not divided from each of the second pixel columns 61. In this case, the second vertical transfer unit 44 is a plurality of transfer electrodes (not illustrated) that transfer the second charge Q2 in the vertical direction along each of the second pixel columns 61. The second horizontal transfer unit 45 is adjacent to the second light receiving unit 6 on an opposite side of the first light receiving unit 5 and extends in the X-axis direction. The second horizontal transfer unit 45 transfers the second charge Q2, transferred from each of the second pixel columns 61 by the second vertical transfer unit 44, in the horizontal direction.

In the present embodiment, the photodetector 4 performs vertical transfer and horizontal transfer by full vertical binning (FVB). On a side of the first light receiving unit 5, the first charges Q1 of the plurality of first pixels 52 are added up for each of the first pixel columns 51 in the first horizontal transfer unit 42. Thereafter, the first charges Q1 added up for each of the first pixel columns 51 in the first horizontal transfer unit 42 are sequentially transferred horizontally from the first horizontal transfer unit 42. The photodetector 4 operates as one frame operation from the start of transfer of the first charge Q1 by the first vertical transfer unit 41 to the end of transfer of the first charge Q1 by the first horizontal transfer unit 42. The first amplifier 43 generates a first electric signal ES1 corresponding to an amount of the first charges Q1 transferred from the first horizontal transfer unit 42. The first electric signal ES1 is, for example, a voltage value. The first electric signal ES1 is AD-converted into a digital value by an AD converter (not illustrated).

On a side of the second light receiving unit 6, the second charges Q2 of the plurality of second pixels 62 are added up for each of the second pixel columns 61 in the second horizontal transfer unit 45. Thereafter, the second charges Q2 added for each of the second pixel columns 61 in the second horizontal transfer unit 45 are sequentially transferred horizontally from the second horizontal transfer unit 45. The photodetector 4 operates as one frame operation from the start of transfer of the second charge Q2 by the second vertical transfer unit 44 to the end of transfer of the second charge Q2 by the second horizontal transfer unit 45. The second amplifier 46 generates a second electric signal ES2 corresponding to an amount of the second charges Q2 transferred from the second horizontal transfer unit 45. The second electric signal ES2 is, for example, a voltage value. The second electric signal ES2 is AD-converted into a digital value by an AD converter (not illustrated).

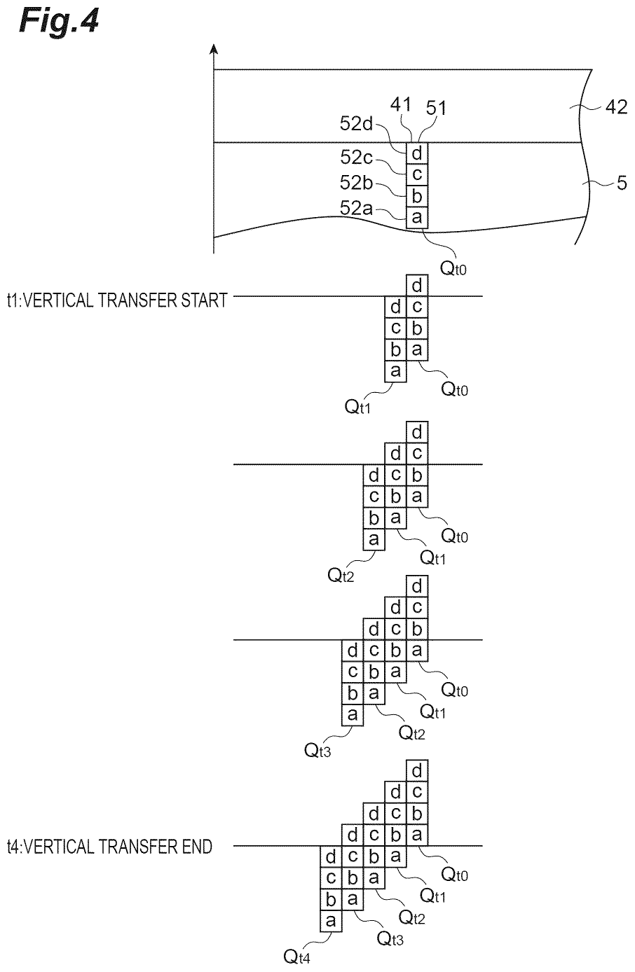

An exposure timing of each of the first pixels 52 per frame operation will be described focusing on one first pixel column 51. First, the exposure timing of each of the first pixels 52 from the start of the vertical transfer of the first charge Q1 by the first vertical transfer unit 41 to the end of the vertical transfer will be described with reference to FIG. 4. Here, in order to simplify the description, a first pixel 52a (schematically indicated as a in FIG. 4), a first pixel 52b (schematically indicated as b in FIG. 4), a first pixel 52c (schematically indicated as c in FIG. 4), and a first pixel 52d (schematically indicated as d in FIG. 4) in a certain first pixel column 51 will be described as an example. It is assumed that the first pixel 52a to the first pixel 52d are arranged in the order of the first pixel 52d, the first pixel 52c, the first pixel 52b, and the first pixel 52a from the side closer to the first horizontal transfer unit 42. Exposure times t0 to t4 indicate predetermined timings in the first exposure time.

Before the exposure time t0, it is assumed that a first charge Qₜ₀ is accumulated in each of the first pixels 52a to 52d in the previous frame operation, and the first charge Qₜ₀ remains without being vertically transferred to the first horizontal transfer unit 42. The vertical transfer in one frame operation is performed until the first charge Qₜ₀ accumulated in the first pixel 52a in the first pixel column 51 is vertically transferred. On the other hand, since the first pixel column 51 is continuously exposed even after the exposure time t1, the first charge Q1 is newly accumulated. The first charge Q1 newly generated at the exposure time t1 is defined as a first charge Qₜ₁, the first charge Q1 newly generated at the exposure time t2 is defined as a first charge Qₜ₂, the first charge Q1 newly generated at the exposure time t3 is defined as a first charge Qₜ₃, and the first charge Q1 newly generated at the exposure time t4 is defined as a first charge Qₜ₄.

First, the first charge Qₜ₀ accumulated in the first pixel 52d at the exposure time t0 is transferred to the first horizontal transfer unit 42. At this time, the first charge Qₜ₁ is newly accumulated. Here, the first charge Qₜ₁ accumulated in the first pixel 52a in the first pixel column 51 is transferred in the next frame operation. Subsequently, at the exposure time t2, the first charge Qₜ₀ accumulated in the first pixel 52c and the first charge Qₜ₁ accumulated in the first pixel 52d are transferred to the first horizontal transfer unit 42. At this time, the first charge Qₜ₂ is newly accumulated. Here, the first charge Qₜ₂ accumulated in the first pixel 52b in the first pixel column 51 will be transferred in the next frame operation. Subsequently, at the exposure time t3, the first charge Qₜ₀ accumulated in the first pixel 52b, the first charge Qₜ₁ accumulated in the first pixel 52c, and the first charge Qₜ₂ accumulated in the first pixel 52d are transferred to the first horizontal transfer unit 42. At this time, the first charge Qₜ₃ is newly accumulated. Here, the first charge Qₜ₃ accumulated in the first pixel 52c in the first pixel column 51 will be transferred in the next frame operation.

Finally, at the exposure time t4, the first charge Qₜ₀ accumulated in the first pixel 52a, the first charge Qₜ₁ accumulated in the first pixel 52b, the first charge Qₜ₂ accumulated in the first pixel 52c, and the first charge Qₜ₃ accumulated in the first pixel 52d are transferred to the first horizontal transfer unit 42. At this time, the first charge Qₜ₄ is newly accumulated. Here, the first charge Qₜ₄ accumulated in the first pixel 52d in the first pixel column 51 is transferred in the next frame operation. As described above, among the exposure timings for the respective first pixels 52 at which the transfer of the first charge Q1 is started in the next frame operation, the timing (exposure time t1) for the first pixel 52a is the earliest and the timing (exposure time t4) for the first pixel 52d is the latest.

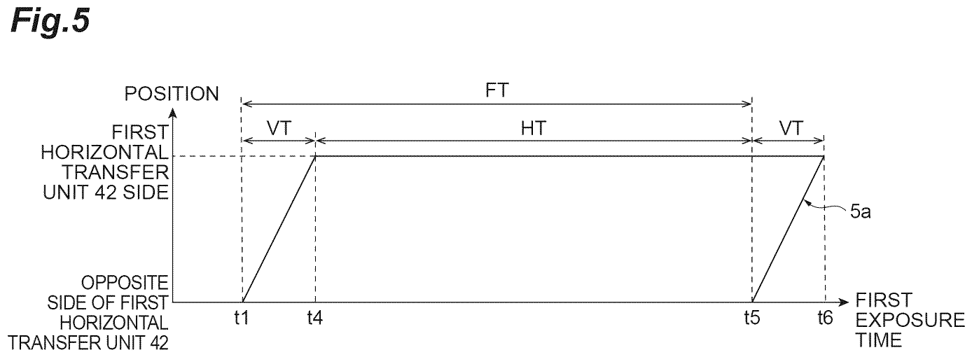

Next, the exposure timing of each of the first pixels 52 including an operation after the end of the vertical transfer will be described with reference to FIG. 5. FIG. 5 illustrates a coordinate system in which the horizontal axis indicates the first exposure time and the vertical axis indicates a position of each of the first pixels 52. The position of each of the first pixels 52 coincides with a position of each of the first pixels 52 in the Y-axis direction in FIG. 3. In FIG. 5, the origin side is an opposite side of the first horizontal transfer unit 42 (the boundary line between the first light receiving unit 5 and the second light receiving unit 6 in FIG. 3). Similarly to FIG. 4, the exposure times t1 to t4 indicate a vertical transfer time VT from a vertical transfer start to a vertical transfer end of the first charge Q1 by the first vertical transfer unit 41. Subsequently, the horizontal transfer by the first horizontal transfer unit 42 is started at the exposure time t4, and the horizontal transfer ends at an exposure time t5. The exposure times t4 to t5 indicate a horizontal transfer time HT. An exposure time obtained by combining the vertical transfer time VT and the horizontal transfer time HT indicates one frame time FT required for one frame operation. Subsequently, the vertical transfer in the next frame operation is started at the exposure time t5, and the vertical transfer in the next frame operation is ended at an exposure time t6.

Between the exposure times t1 and t4, as described with reference to FIG. 4, the exposure timing for each of the first pixels 52 at which the transfer of the first charge Q1 is started in the next frame operation is later for each of the first pixels 52 on a side of the first horizontal transfer unit 42 and earlier for each of the first pixels 52 on the opposite side of the first horizontal transfer unit 42. Between the exposure times t4 and t5, all of the plurality of first pixels 52 are exposed at the same timing while the first charge Q1 remaining without being vertically transferred in the previous frame operation is horizontally transferred. Between the exposure times t5 and t6, the exposure is performed on each of the first pixels 52 in which the transfer of the first charge Q1 is started in the next frame operation. That is, between the exposure times t5 and t6, the exposure on each of the first pixels 52 in which the transfer of the first charge Q1 is started in the next frame operation ends. A timing at which the exposure ends is later for each of the first pixels 52 on the side of the first horizontal transfer unit 42, and earlier for each of the first pixels 52 on the opposite side of the first horizontal transfer unit 42. As described above, a shape of a region 5a of the exposure timing, formed in the coordinate system in which the horizontal axis indicates the first exposure time and the vertical axis indicates the position of each of the first pixels 52, is a parallelogram in which opposing short sides are inclined in a case where long sides are on the horizontal axis and the short sides are on the vertical axis.

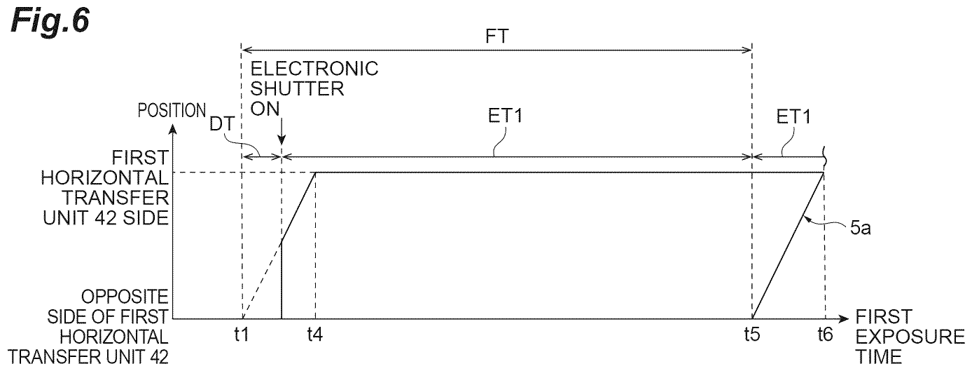

The photodetector 4 can set the first exposure time to a time shorter than one frame time FT. At that time, the photodetector 4 discards the accumulated first charge Q1 from the start of one frame time FT over a predetermined time (charge discarding time) using an electronic shutter function. Accordingly, the photodetector 4 may set the remaining time of one frame time FT as the first exposure time. As illustrated in FIG. 6, in a case where the electronic shutter is operated between the exposure time t1 and the exposure time t4, the first charges Q1 vertically transferred to the first horizontal transfer unit 42 during the vertical transfer and the first charges Q1 accumulated in the plurality of first pixels 52 during the vertical transfer are all discarded for a charge discarding time DT. When a first exposure time ET1 is started, the vertical transfer and the accumulation of the first charge Q1 are resumed.

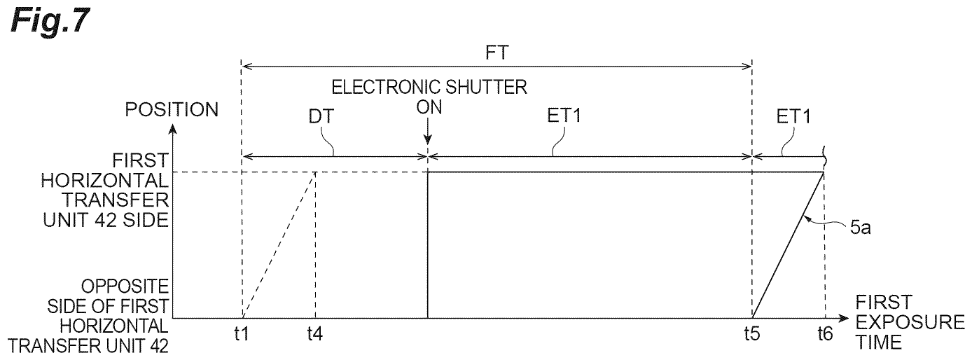

As illustrated in FIG. 7, in a case where the electronic shutter is operated between the exposure time t4 and the exposure time t5, in addition to the first charges Q1 discarded in the case of FIG. 6, all the first charges Q1 accumulated in the plurality of first pixels 52 during the horizontal transfer are discarded. When the first exposure time ET1 is started, the horizontal transfer and the accumulation of the first charge Q1 are resumed. The region 5a in the case where the electronic shutter is operated between the exposure time t4 and the exposure time t5 has a trapezoid shape. Specifically, in a case where the side of the first horizontal transfer unit 42 is an upper side and the opposite side of the first horizontal transfer unit 42 is a lower side, the region 5a has the trapezoid shape in which the upper side is longer than the lower side. In a case where the region 5a has the trapezoid shape, the amount of the first charge Q1 transferred to the first horizontal transfer unit 42 at the end of the exposure time t6 is such that the amount of charge accumulated in each of the first pixels 52 on the side of the first horizontal transfer unit 42 is large, and the amount of charge accumulated in each of the first pixels 52 on the opposite side of the first horizontal transfer unit 42 is small.

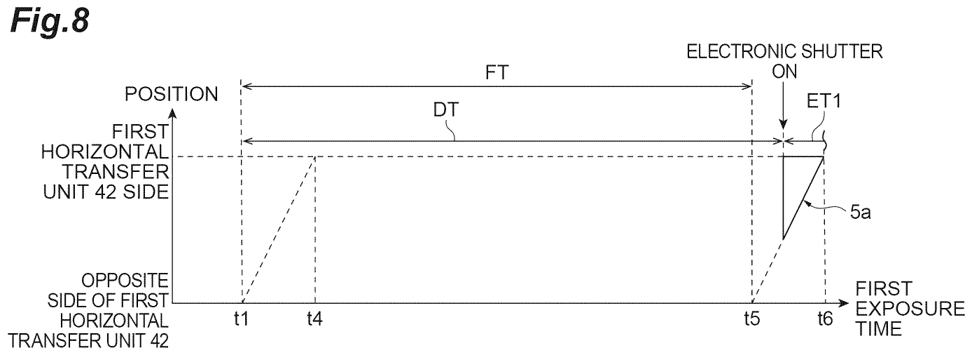

As illustrated in FIG. 8, in a case where the electronic shutter is operated between the exposure time t5 and the exposure time t6, in addition to the first charges Q1 discarded in the case of FIG. 7, the first charges Q1 vertically transferred to the first horizontal transfer unit 42 during the vertical transfer in the next frame operation and the first charges Q1 accumulated in the plurality of first pixels 52 during the vertical transfer are all discarded. When the first exposure time ET1 is started, the vertical transfer and the accumulation of the first charge Q1 in the next frame operation are resumed. The region 5a in the case where the electronic shutter is operated between the exposure time t5 and the exposure time t6 has a triangle shape. Specifically, the region 5a has a triangle shape having a bottom side on the side of the first horizontal transfer unit 42 and a vertex on the opposite side of the first horizontal transfer unit 42. In a case where the region 5a has the triangle shape, the first charge Q1 transferred to the first horizontal transfer unit 42 at the end of the exposure time t6 is, for example, only the charge accumulated in each of the first pixels 52 on the side of the first horizontal transfer unit 42.

### [Generation of Spectrum Data by Analysis Unit]

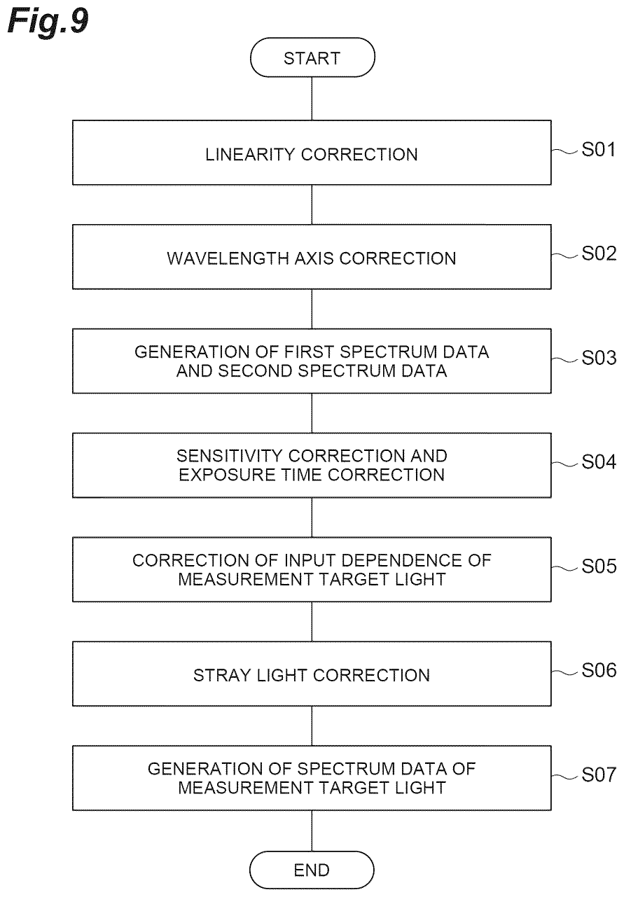

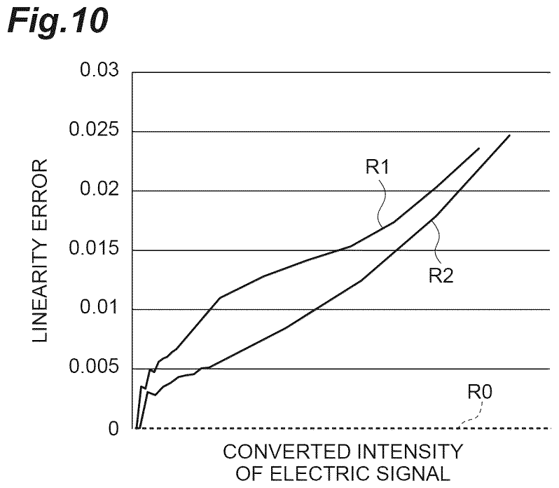

As illustrated in FIG. 9, the analysis unit 70 generates spectrum data of the measurement target light L1 through a plurality of correction steps. The analysis unit 70 first performs linearity correction (S01). As an example of the linearity correction, as illustrated in FIG. 10, a linearity characteristic R1 of the first amplifier 43 and a linearity characteristic R2 of the second amplifier 46 do not completely match. In addition, the linearity characteristic R1 of the first amplifier 43 and the linearity characteristic R2 of the second amplifier 46 deviate from a reference linearity characteristic R0. The linearity characteristic R1 of the first amplifier 43 and the linearity characteristic R2 of the second amplifier 46 are represented by a graph in which the horizontal axis indicates a converted intensity of an electric signal and the vertical axis indicates a linearity error. In the linearity characteristic R1 of the first amplifier 43, a converted intensity of the first electric signal ES1 is calculated by (reference intensity/reference exposure time)×the first exposure time ET1. In the linearity characteristic R2 of the second amplifier 46, a converted intensity of the second electric signal ES2 is calculated by (reference intensity/reference exposure time)×the second exposure time ET2. The linearity error is represented by an absolute value of a difference between an intensity of the first electric signal ES1 and the converted intensity of the first electric signal ES1 in the case of the first amplifier 43, and is represented by an absolute value of a difference between an intensity of the second electric signal ES2 and the converted intensity of the second electric signal ES2 in the case of the second amplifier 46. In addition, the reference intensity is defined as a signal intensity acquired during the reference exposure time. The reference exposure time is set to an exposure time as short as possible within a range in which data reliability can be secured.

The linearity error of the reference linearity characteristic R0 is zero based on the above linearity error calculation formula. In the linearity characteristic R1 of the first amplifier 43 and the linearity characteristic R2 of the second amplifier 46, the magnitude of the linearity error increases as the converted intensity of the electric signal increases. As the linearity characteristic R1 of the first amplifier 43 and the linearity characteristic R2 of the second amplifier 46 are made to match with the reference linearity characteristic R0, it is possible to correct the linearity error of each of the linearity characteristic R1 of the first amplifier 43 and the linearity characteristic R2 of the second amplifier 46.

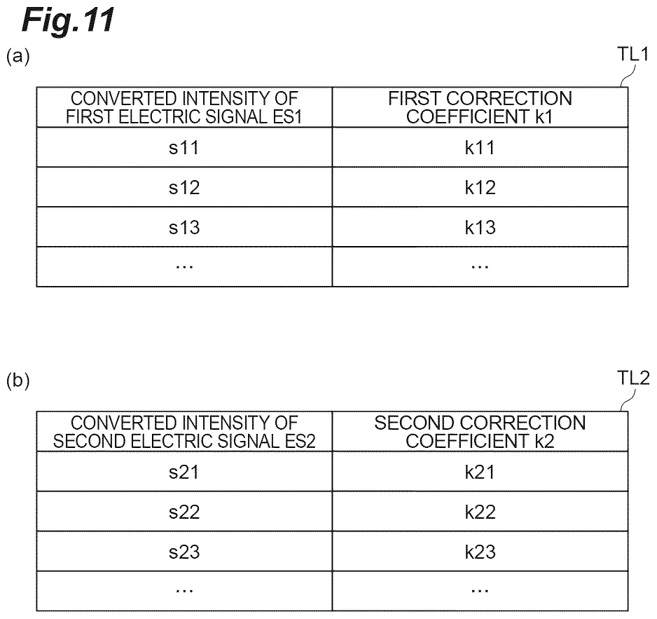

In the linearity correction, the analysis unit 70 corrects the first electric signal ES1 using a first correction coefficient k1. As illustrated in part (a) of FIG. 11, the analysis unit 70 stores a table TL1 of the first correction coefficient k1 corresponding to the converted intensity of first electric signal ES1 in the storage unit 7. The first correction coefficient k1 is determined in advance according to the linearity characteristic R1 of the first amplifier 43. The analysis unit 70 multiplies the first electric signal ES1 by the first correction coefficient k1 to match with the linearity characteristic R1 of the first amplifier 43 with the reference linearity characteristic R0. Therefore, the first correction coefficient k1 is determined such that a correction amount of the linearity characteristic R1 increases as the converted intensity of the first electric signal ES1 increases. The converted intensity of the first electric signal ES1 is calculated as follows, for example. An operator who performs spectrometry using the spectrometry device 1 gives an instruction regarding a value of the first exposure time ET1 to the analysis unit 70 using the input unit connected to the analysis unit 70. Then, the analysis unit 70 calculates the converted intensity of the first electric signal ES1 based on the instructed value. For example, when the calculated converted intensity of the first electric signal ES1 is s11, the analysis unit 70 reads k11 from the table TL1 as the corresponding first correction coefficient k1. Then, the analysis unit 70 corrects the first electric signal ES1 using the k11 read out from the table TL1.

In the linearity correction, the analysis unit 70 corrects the second electric signal ES2 using a second correction coefficient k2. As illustrated in part (b) of FIG. 11, the analysis unit 70 stores a table TL2 of the second correction coefficient k2 corresponding to the converted intensity of second electric signal ES2 in the storage unit 7. The second correction coefficient k2 is determined in advance according to the linearity characteristic R2 of the second amplifier 46. The analysis unit 70 multiplies the second electric signal ES2 by the second correction coefficient k2 to match with the linearity characteristic R2 of the second amplifier 46 with the reference linearity characteristic R0. Therefore, the second correction coefficient k2 is determined such that a correction amount of the linearity characteristic R2 increases as the converted intensity of the second electric signal ES2 increases. The converted intensity of the second electric signal ES2 is calculated as follows, for example. The operator who performs spectrometry using the spectrometry device 1 gives an instruction to the analysis unit 70 using the input unit connected to the analysis unit 70. Then, the analysis unit 70 calculates the converted intensity of the second electric signal ES2 based on an instructed value. For example, when the calculated converted intensity of the second electric signal ES2 is s21, the analysis unit 70 reads k21 from the table TL2 as the corresponding second correction coefficient k2. Then, the analysis unit 70 corrects the second electric signal ES2 using the k21 read out from the table TL2. Note that either the correction of the first electric signal ES1 or the correction of the second electric signal ES2 may be performed first, or the both corrections may be performed simultaneously.

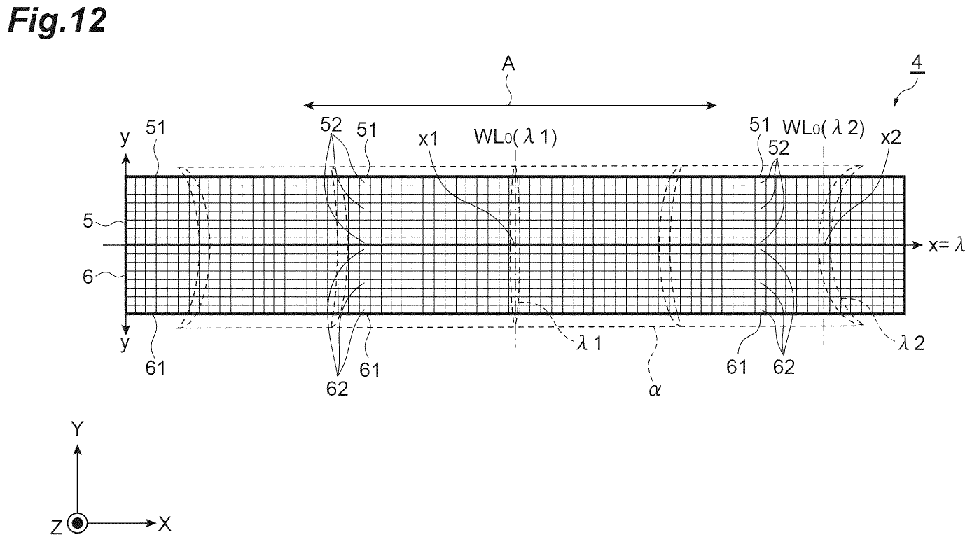

Subsequently, the analysis unit 70 performs wavelength axis correction (S02). As illustrated in FIG. 12, there are a case where an image for each wavelength of the spectral image α is an image (image with a wavelength 21) having a shape parallel to the Y-axis direction and a case where the image is an image (image with a wavelength λ2) having an arcuate shape due to characteristics of the optical system 3. The analysis unit 70 sets a coordinate system in which a boundary line between the first light receiving unit 5 and the second light receiving unit 6 is an x axis and an axis perpendicular to the x axis is a y axis. In the coordinate system, the analysis unit 70 sets a first correspondence relationship between a position on the wavelength axis of each of the plurality of first pixel columns 51 and a wavelength on the wavelength axis, and a second correspondence relationship between a position on the wavelength axis of each of the plurality of second pixel columns 61 and a wavelength on the wavelength axis. The position on the wavelength axis of each of the plurality of first pixel columns 51 and the position on the wavelength axis of each of the plurality of second pixel columns 61 are set at a reference x coordinate WL₀(λ). The reference x coordinate WL₀(λ) is an x coordinate of a point at which an image for each wavelength intersects the x axis. For example, a reference x coordinate WL₀(λ1) of the image with the wavelength λ1 is x1, and a reference x coordinate WL₀(λ2) of the image with the wavelength λ2 is x2.

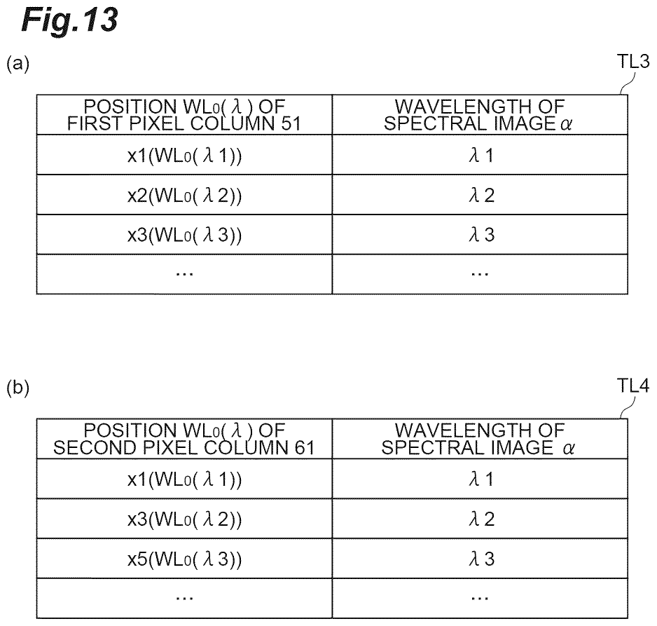

A position on the wavelength axis of the first pixel column 51 and a position on the wavelength axis of the second pixel column 61 where an image of a certain wavelength within the spectral image α is formed may deviate due to the characteristics of the optical system 3. In addition, the position on the wavelength axis of the first pixel column 51 and the position on the wavelength axis of the second pixel column 61 may have individual differences for each of the spectrometry devices 1. Therefore, the position on the wavelength axis of the first pixel column 51 is measured in advance for each of the spectrometry devices 1, and the analysis unit 70 stores the measured result as a table TL3 of the first correspondence relationship as illustrated in (a) of FIG. 13. Similarly, the position on the wavelength axis of the second pixel column 61 is measured in advance for each of the spectrometry devices 1, and the analysis unit 70 stores the measured result as a table TL4 of the second correspondence relationship as illustrated in (b) of FIG. 13. For example, in (a) of FIG. 13, a position of the first pixel column 51 corresponding to a wavelength λ3 is x3. This x3 is a reference x coordinate WL₀(λ3) in the first pixel column 51. On the other hand, in (b) of FIG. 13, a position of the second pixel column 61 corresponding to the wavelength 23 deviates from the first pixel column 51 and is x5. This x5 is a reference x coordinate WL₀(λ3) in the second pixel column 61. The analysis unit 70 generates first spectrum data to be described later based on the first correspondence relationship TL3, and generates second spectrum data to be described later based on the second correspondence relationship TL4.

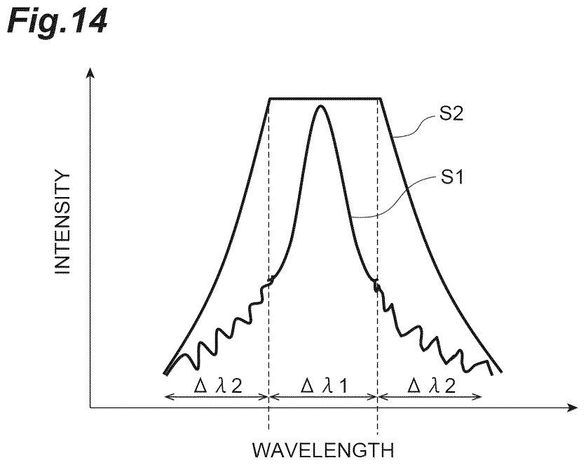

Subsequently, the analysis unit 70 performs the generation of the first spectrum data and the second spectrum data (S03). In step S03, the analysis unit 70 generates the first spectrum data based on the corrected first electric signal ES1. In addition, the analysis unit 70 generates the second spectrum data based on the corrected second electric signal ES2. As illustrated in FIG. 14, in first spectrum data S1, the analysis unit 70 can acquire the intensity in all wavelength bands without the plurality of first pixels 52 being saturated in any of the wavelength bands. On the other hand, second spectrum data S2 includes a wavelength band (saturation wavelength band Δλ1) in which the plurality of second pixels 62 are saturated. Therefore, the analysis unit 70 cannot accurately acquire the intensity in the saturation wavelength band Δλ1. When a wavelength band excluding the saturation wavelength band Δλ1 is a non-saturation wavelength band Δλ2, noise is superimposed in the non-saturation wavelength band Δλ2 so that S/N is poor in the first spectrum data S1. On the other hand, in the second spectrum data S2, noise is not superimposed even in the non-saturation wavelength band Δλ2, and the analysis unit 70 can acquire highly accurate data.

Subsequently, the analysis unit 70 performs sensitivity correction and exposure time correction (S04). In the sensitivity correction, when the first light receiving unit 5 and the second light receiving unit 6 are exposed for the same exposure time, the analysis unit 70 generates a function I_{calib_S}(λ) (first function) of the first spectrum data S1 and a function I_{calib_L}(λ) (second function) of the second spectrum data S2. Then, the analysis unit 70 corrects at least one of the first spectrum data S1 and the second spectrum data S2 based on a ratio between the function I_{calib_S}(λ) and the function I_{calib_L}(λ). Since the function I_{calib_S}(λ) and the function I_{calib_L}(λ) ideally have the same value, the ratio between them is ideally one. However, a light receiving sensitivity of the first light receiving unit 5 and a light receiving sensitivity of the second light receiving unit 6 do not always match, and such a deviation is corrected by the sensitivity correction. A sensitivity correction coefficient SR_{calib}(λ) is expressed by Formula 1.

$${SR}_{calib} ( λ ) = {I}_{calib\_L} ( λ ) / {I}_{calib\_S} ( λ ) \qquad ( 1 )$$

In the exposure time correction, the analysis unit 70 corrects at least one of the first spectrum data S1 and the second spectrum data S2 based on a ratio between the first exposure time ET1 and the second exposure time ET2. An exposure time correction coefficient DRGain is represented by Formula 2.

$$DRGain = ET 2 / ET 1 \qquad ( 2 )$$

When an intensity I_{L}(λ) in the second spectrum data S2 is corrected using the sensitivity correction coefficient SR_{calib}(λ) and the exposure time correction coefficient DRGain, a corrected intensity I_{L}(λ)′ is expressed by Formula 3.

$${{I}_{L} ( λ )}^{′} = {I}_{L} ( λ ) / ( {SR}_{calib} ( λ ) \times DRGain \qquad ( 3 )$$

Note that, when an intensity I_{S}(λ) in the first spectrum data S1 is corrected, I_{S}(λ) is multiplied by the sensitivity correction coefficient SR_{calib}(λ)×the exposure time correction coefficient DRGain.

Subsequently, the analysis unit 70 corrects input dependence of the measurement target light L1 (S05). The measurement target light L1 is preferably received in the first light receiving unit 5 and the second light receiving unit 6 with the same intensity. However, there is a case where the intensity distribution in a cross section of the measurement target light L1 is non-uniform in the plane when the measurement target light L1 is incident on the optical system 3. In this case, there may be a difference between a light intensity in the first pixel column 51 on which an optical image of a certain wavelength of the spectral image α is formed and a light intensity in the second pixel column 61 on which the optical image is formed. In other words, the first light receiving unit 5 and the second light receiving unit 6 may be affected by the input dependence of the measurement target light L1. In correction of the input dependence, the analysis unit 70 corrects the above-described difference in the light intensity.

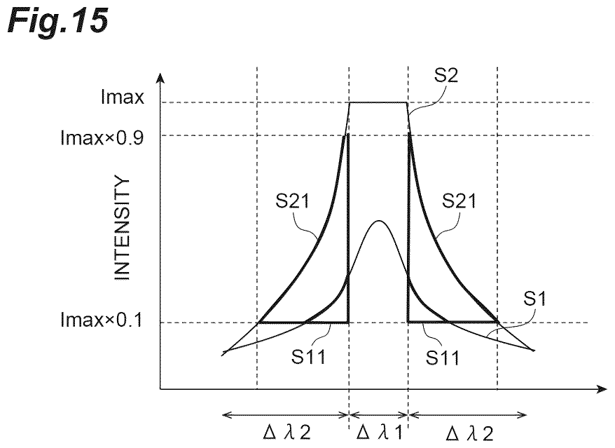

In the correction of the input dependence, the analysis unit 70 corrects at least one of the first spectrum data S1 and the second spectrum data S2 based on a ratio between a representative value of the intensity of the first spectrum data S1 in the non-saturation wavelength band Δλ2 and a representative value of the intensity of the second spectrum data S2 in the non-saturation wavelength band Δλ2. Here, for example, as illustrated in FIG. 15, the representative values are a first area S11 of the first spectrum data S1 and a second area S21 of the second spectrum data S2. Alternatively, the representative values may be a median value of the intensity of the first spectrum data S1 and a median value of the intensity of the second spectrum data S2. A range of the intensity in calculating the first area S11 and the second area S21 by the analysis unit 70 is a range between Imax×0.9 and Imax×0.1 when a value at which the intensity is saturated in the second spectrum data S2 is Imax. Since the range between Imax×0.9 and Imax×0.1 is a range having a relatively good linearity characteristic, the accuracy of the correction can be improved. Here, the good linearity characteristic means a range in which an increase rate of the linearity error in the linearity characteristic R1 and the linearity characteristic R2 is relatively gentle in FIG. 10, for example.

A range of the wavelength in calculating the first area S11 and the second area S21 is the non-saturation wavelength band Δλ2. The first area S11 is an area surrounded by the range between Imax×0.9 and Imax×0.1, and by the non-saturation wavelength band Δλ2 in the first spectrum data S1. The second area S21 is an area surrounded by the range between Imax×0.9 and Imax×0.1, and by the non-saturation wavelength band Δλ2 in the second spectrum data S2. The analysis unit 70 corrects at least one of the first spectrum data S1 and the second spectrum data S2 based on a correction coefficient IR of the input dependence that is a ratio between the first area S11 and the second area S21. When the intensity I_{L}(λ) in the second spectrum data S2 is corrected using the correction coefficient IR of the input dependence, the sensitivity correction coefficient SR_{calib}(λ), and the exposure time correction coefficient DRGain, a corrected intensity I_{L}(λ)′ is expressed by Formula 4.

$$Intensity {I}_{L} ( λ ) ' = {I}_{L} ( λ ) / ( {SR}_{calib} ( λ ) \times DRGain \times IR ) \qquad ( 4 )$$

Note that, when the intensity I_{S}(λ) in the first spectrum data S1 is corrected, I_{S}(λ) is multiplied by the sensitivity correction coefficient SR_{calib}(λ)×the exposure time correction coefficient DRGain×the correction coefficient IR of the input dependence.

Subsequently, the analysis unit 70 performs stray light correction (S06). As described above, the second spectrum data S2 is superior to the first spectrum data S1 in terms of S/N in the non-saturation wavelength band Δλ2. Therefore, in the generation of spectrum data of the measurement target light L1 to be described later, a decrease in detection accuracy can be suppressed by using the second spectrum data S2 in the non-saturation wavelength band Δλ2. However, when stray light is generated in the second spectrum data S2, the stray light is also generated in the spectrum data of the measurement target light L1, and the detection accuracy decreases. The stray light is generated in the optical system 3, for example, when a part of the measurement target light L1 is reflected multiple times in the lens 33. In the stray light correction, the analysis unit 70 performs correction to remove the stray light generated in the optical system 3 on the second spectrum data S2 in the non-saturation wavelength band Δλ2.

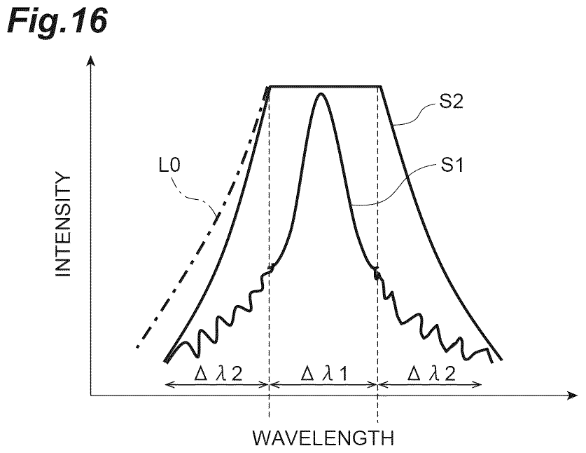

As illustrated in FIG. 16, stray light L0 is generated in the non-saturation wavelength band Δλ2 of the second spectrum data S2. The analysis unit 70 removes the stray light L0 as follows, for example. The analysis unit 70 calculates a stray light signal distribution matrix obtained by quantifying an intensity of the stray light L0 in the second spectrum data S2. Subsequently, the analysis unit 70 derives a stray light correction matrix by obtaining an inverse matrix of a sum of the stray light signal distribution matrix and an identity matrix having the same number of rows and columns as the stray light signal distribution matrix. Then, the analysis unit 70 corrects the stray light L0 by matrix multiplication based on the stray light correction matrix.

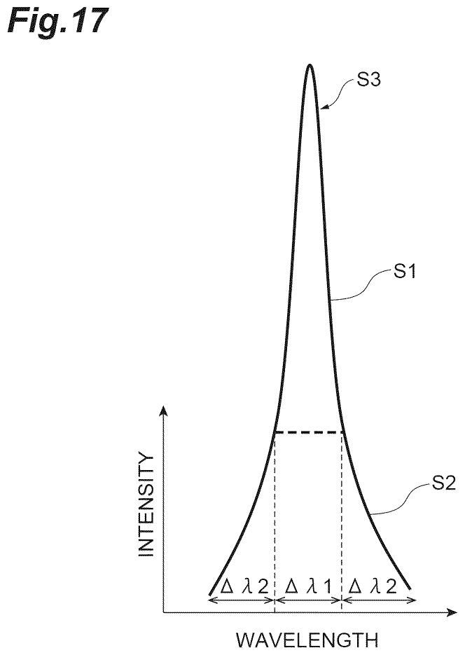

The analysis unit 70 finally performs the generation of spectrum data of the measurement target light L1 (S07). As illustrated in FIG. 17, the analysis unit 70 generates spectrum data S3 of the measurement target light L1 by coupling data of the saturation wavelength band Δλ1 of the first spectrum data S1 and data of the non-saturation wavelength band Δλ2 of the second spectrum data S2. For example, with respect to the first spectrum data S1, the analysis unit 70 divides the corrected first electric signal ES1 by the first exposure time ET1, and multiplies a result of the division by the reference exposure time. On the other hand, with respect to the second spectrum data S2, the analysis unit 70 divides the corrected second electric signal ES2 by the second exposure time ET2, and multiplies a result of the division by the reference exposure time. Accordingly, the analysis unit 70 matches the scale of the first spectrum data S1 with the scale of the second spectrum data S2, and then generates the spectrum data S3 of the measurement target light L1. In the spectrum data S3, the intensity in all the wavelength bands can be acquired without saturation of each pixel in all the wavelength bands and without superimposition of noise.

### Functions and Effects

In the spectrometry device 1, the photodetector 4 receives the spectral image α for the first exposure time ET1 in the first light receiving unit 5 and outputs the first electric signal ES1, and receives the spectral image α for the second exposure time ET2 longer than the first exposure time ET1 in the second light receiving unit 6 and outputs the second electric signal ES2, and the analysis unit 70 generates the first spectrum data S1 based on the first electric signal ES1 and generates the second spectrum data S2 based on the second electric signal ES2. Then, the analysis unit 70 generates the spectrum data S3 of the measurement target light L1 based on the first spectrum data S1 and the second spectrum data S2. Thus, the spectrum data S3 of the measurement target light L1 can be generated in a wide dynamic range. Furthermore, in the spectrometry device 1, the analysis unit 70 corrects the first electric signal ES1 using the first correction coefficient k1 and corrects the second electric signal ES2 using the second correction coefficient k2. As a result, it is possible to correct the error generated in each of the linearity characteristic R1 of the first amplifier 43 and the linearity characteristic R2 of the second amplifier 46. Therefore, the spectrometry device 1 can acquire the spectrum data S3 of the measurement target light L1 with high accuracy.

In the spectrometry device 1, the analysis unit 70 generates the first spectrum data S1 based on the first correspondence relationship between each of the plurality of first pixel columns 51 and the wavelength on the wavelength axis, and generates the second spectrum data S2 based on the second correspondence relationship between each of the plurality of second pixel columns 61 and the wavelength on the wavelength axis. In the spectrometry device 1, there may be a deviation between a position of the first pixel column 51 on which an optical image of a certain wavelength of the spectral image α is formed and a position of the second pixel column 61 on which the optical image is formed. According to the spectrometry device 1, even when such a positional deviation occurs, it is possible to acquire the first spectrum data S1 and the second spectrum data S2 in which such a positional deviation is corrected.

In the spectrometry device 1, the analysis unit 70 corrects at least one of the first spectrum data S1 and the second spectrum data S2 based on the ratio between the representative value of the intensity of the first spectrum data S1 and the representative value of the intensity of the second spectrum data S2. In the spectrometry device 1, there may be a difference between a light intensity in the first pixel column 51 on which an optical image of a certain wavelength of the spectral image α is formed and a light intensity in the second pixel column 61 on which the optical image is formed. According to the spectrometry device 1, even when such a difference in the light intensity occurs, it is possible to acquire the first spectrum data S1 and the second spectrum data S2 in which such a difference in the light intensity is corrected.

In the spectrometry device 1, the analysis unit 70 performs correction on the second spectrum data S2 to remove the stray light L0 generated in the optical system 3. When focusing only on noise generated on a circuit (for example, noise generated on the control board 8), S/N of the second spectrum data S2 is higher than S/N of the first spectrum data S1. However, there is a case where the measurement target light L1 includes the stray light L0, and in this case, noise caused by the stray light L0 increases as the second exposure time ET2 is longer than the first exposure time ET1, and the S/N of the second spectrum data S2 decreases. According to the spectrometry device 1, even when the measurement target light L1 includes the stray light L0, it is possible to acquire the second spectrum data S2 from which such stray light L0 has been removed.

The spectrometry device 1 further includes the fiber bundle 2 including the plurality of optical fibers that guide the measurement target light L1 to the optical system 3 and having the circular incident end face 2a and the elongated emitting end face 2b. The plurality of optical fibers include the plurality of first optical fibers 21 disposed on one side with respect to the center of the emitting end face 2b in the emitting end face 2b and the plurality of second optical fibers 22 disposed on the other side with respect to the center of the emitting end face 2b in the emitting end face 2b. On the incident end face 2a, each of the plurality of first optical fibers 21 and each of the plurality of second optical fibers 22 are adjacent to each other in at least one of the circumferential direction and the radial direction. In the spectrometry device 1, even when the light intensity of the measurement target light L1 is biased on the incident end face 2a of the fiber bundle 2, the bias of the light intensity of the measurement target light L1 is suppressed in the emitting end face 2b of the fiber bundle 2. Therefore, according to the spectrometry device 1, when focusing on the first pixel column 51 and the second pixel column 61 on which the optical image of the certain wavelength of the spectral image α is formed, it is possible to acquire the first spectrum data S1 and the second spectrum data S2 while suppressing the occurrence of the difference between the light intensity in the first pixel column 51 and the light intensity in the second pixel column 61.

In the spectrometry device 1, the photodetector 4 has the electronic shutter function that discharges the first charge Q1 accumulated in each of the plurality of first pixels 52 over a predetermined time (the charge discarding time DT) from the start of one frame time FT in the one frame time FT1 between the start of transfer of the first charge Q1 by the first vertical transfer unit 41 and the end of transfer of the first charge Q1 by the first horizontal transfer unit 42, thereby the electronic shutter function that sets a time excluding the predetermined time in the one frame time FT as the first exposure time ET1. According to the spectrometry device 1, it is possible to prevent each of the first pixels 52 from being saturated in the first light receiving unit 5 and to reliably acquire the first spectrum data S1 in the saturation wavelength band Δλ1 by using the electronic shutter function for the first light receiving unit 5.

In the spectrometry device 1, when the first light receiving unit 5 and the second light receiving unit 6 are exposed for the same exposure time, the analysis unit 70 generates the first function of the first spectrum data S1 and the second function of the second spectrum data S2, and corrects at least one of the first spectrum data S1 and the second spectrum data S2 based on a ratio between the first function and the second function. In the spectrometry device 1, the light receiving sensitivity of the first light receiving unit 5 and the light receiving sensitivity of the second light receiving unit 6 do not always match. According to the spectrometry device 1, even when a deviation between the light receiving sensitivities occurs, it is possible to acquire the first spectrum data S1 and the second spectrum data S2 in which the deviation between the light receiving sensitivities is corrected.

In the spectrometry device 1, the analysis unit 70 corrects at least one of the first spectrum data S1 and the second spectrum data S2 based on the ratio between the first exposure time ET1 and the second exposure time ET2. According to the spectrometry device 1, it is possible to acquire the first spectrum data S1 and the second spectrum data S2 in which influence on the light intensity due to a difference in the exposure time is corrected.

In the spectrometry device 1, the photodetector 4 receives the spectral image α for the first exposure time ET1 in the first light receiving unit 5 and outputs the first electric signal ES1, and receives the spectral image α for the second exposure time ET2 longer than the first exposure time ET1 in the second light receiving unit 6 and outputs the second electric signal ES2. The storage unit 7 stores the first correction coefficient k1 for correcting the first electric signal ES1 and the second correction coefficient k2 for correcting the second electric signal ES2. Therefore, when the spectrum data S3 of the measurement target light L1 is generated based on the first electric signal ES1 and the second electric signal ES2, the error generated in each of the linearity characteristic R1 of the first amplifier 43 and the linearity characteristic R2 of the second amplifier 46 can be corrected by correcting the first electric signal ES1 using the first correction coefficient k1 and correcting the second electric signal ES2 using the second correction coefficient k2. Therefore, the spectrometry device 1 can acquire the spectrum data S3 of the measurement target light L1 with high accuracy.

According to a spectrometry method, it is possible to acquire the spectrum data S3 of the measurement target light L1 with high accuracy for the same reason as the spectrometry device 1.

### MODIFICATIONS

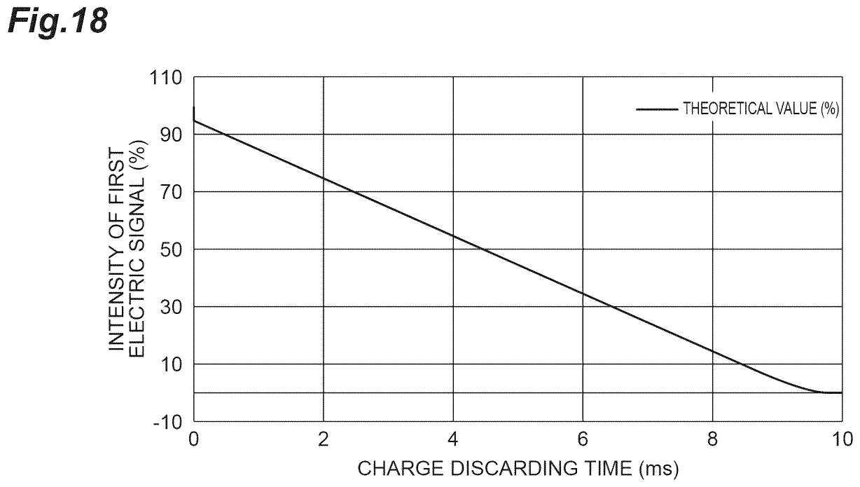

The present disclosure is not limited to the above embodiment. In a case where the photodetector 4 sets the first exposure time ET1 to a time shorter than one frame time FT using the electronic shutter function, the intensity of the first electric signal ES1 decreases as the charge discarding time DT increases as illustrated in FIG. 18. In FIG. 18, the horizontal axis indicates the charge discarding time DT, and the vertical axis indicates the intensity of the first electric signal ES1. Here, the intensity of the first electric signal ES1 is indicated by % display according to the charge discarding time DT assuming that the intensity of the first electric signal ES1 when the charge discarding time DT is 0 ms is 100%. When the charge discarding time DT is 0 ms, the photodetector 4 does not operate the electronic shutter. When the charge discarding time DT is around 0.1 ms, the intensity of the first electric signal ES1 rapidly decreases. That is, when the electronic shutter is operated by the photodetector 4 from an unoperated state, the first electric signal ES1 decreases rapidly. When the charge discarding time DT is between around 0.2 ms and around 8.3 ms, the first electric signal ES1 decreases linearly in inverse proportion to the charge discarding time DT. When the photodetector 4 operates the electronic shutter during this period, the region 5a has the trapezoid shape as described with reference to FIG. 7. When the charge discarding time DT is between around 8.4 ms and around 10 ms, the first electric signal ES1 decreases non-linearly in inverse proportion to the charge discarding time DT. When the photodetector 4 operates the electronic shutter during this time, the region 5a has the triangular shape as described with reference to FIG. 8.

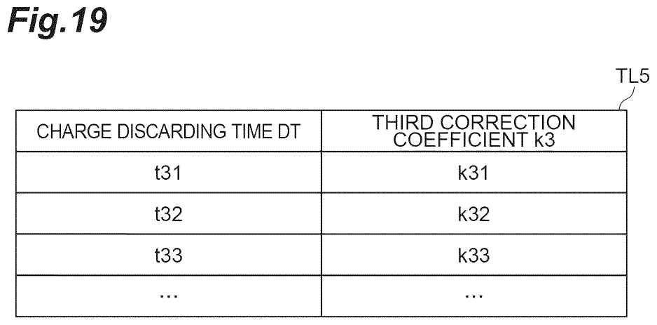

As illustrated in FIG. 19, the analysis unit 70 stores a table TL5 in which a third correction coefficient k3 is associated with the charge discarding time DT in the storage unit 7. As described above, when the electronic shutter function is used, the intensity of the first electric signal ES1 decreases according to the length of the charge discarding time DT. The intensity of the first electric signal ES1 may decrease linearly, or may decrease non-linearly or rapidly. Accordingly, since the linearity characteristic R1 of the first amplifier 43 changes, it becomes difficult to make the linearity characteristic R1 match with the reference linearity characteristic R0 with the first correction coefficient k1 in performing the linearity correction (S01) of the first amplifier 43. Therefore, the third correction coefficient k3 is calculated for each charge discarding time DT by actual measurement or simulation based on the decreasing tendency of the intensity of the first electric signal ES1 corresponding to the charge discarding time DT. The analysis unit 70 stores a calculated result as the table TL5 of the third correction coefficient k3 corresponding to the charge discarding time DT. The analysis unit 70 corrects the first electric signal ES1 using the third correction coefficient k3 instead of the first correction coefficient k1. Accordingly, even when the electronic shutter function is used, the linearity characteristic R1 of the first amplifier 43 matches with the reference linearity characteristic R0. Accordingly, it is possible to acquire the first spectrum data S1 in which the error occurring in the linearity characteristic R1 of the first amplifier 43 is corrected. Note that the analysis unit 70 may store the third correction coefficient k3 corresponding to the first exposure time ET1 as the table TL5. Alternatively, the analysis unit 70 may store the third correction coefficient k3 corresponding to the converted intensity of first electric signal ES1 as the table TL5.

When the photodetector 4 uses the electronic shutter function to set the first exposure time ET1 to the time shorter than one frame time FT, only the first charges Q1 accumulated in some of the first pixels 52 may be transferred vertically and horizontally. For example, as illustrated in FIG. 8, when the region 5a has the triangular shape, the first charge Q1 transferred to the first horizontal transfer unit 42 at the end of the exposure time t6 is only the charge accumulated in each of the first pixels 52 on the side of the first horizontal transfer unit 42. In this case, in FIG. 12, among the first pixels 52 on which the image with the wavelength λ2 is formed, only the first charges Q1 accumulated in some of the first pixels 52 close to the first horizontal transfer unit 42 are transferred. Some of the first pixels 52 close to the first horizontal transfer unit 42 deviate from the reference x coordinate WL₀(λ2). Therefore, the first electric signal ES1 corresponding to the wavelength λ2 is not transferred from the x coordinate x2 of the reference x coordinate WL₀(λ2). That is, the first correspondence relationship in a case where the electronic shutter function is used changes from the first correspondence relationship in a case where the electronic shutter function is not used.

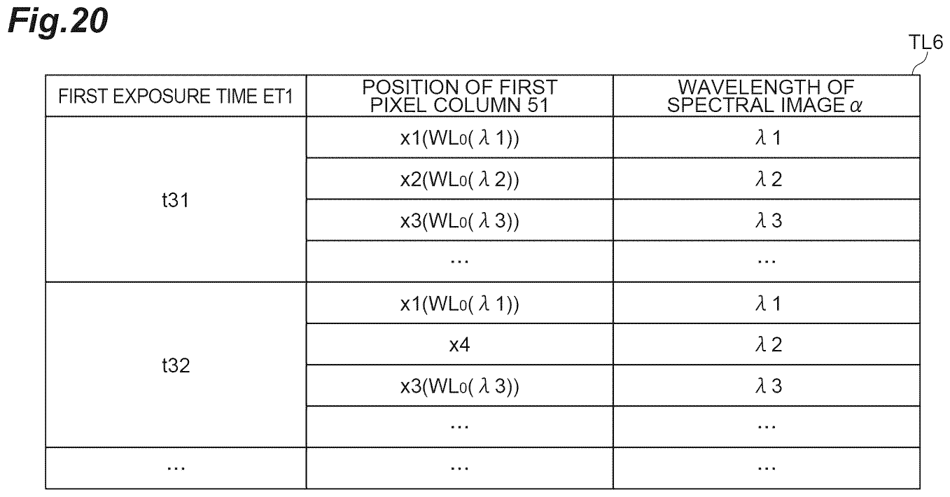

Therefore, the first correspondence relationship corresponding to the length of the first exposure time ET1 is measured in advance, and the analysis unit 70 stores a measured result in the storage unit 7 as a table TL6 of a corrected first correspondence relationship as illustrated in FIG. 20. For example, in FIG. 20, in a case where the first exposure time ET1 is set to t32, the region 5a is assumed to have the triangular shape as illustrated in FIG. 8. In this case, a position of the first pixel column 51 corresponding to the wavelength λ2 is not x2 corresponding to the reference x coordinate WL₀(λ2) but x4 in consideration of a deviation from the reference x coordinate WL₀(λ2). The analysis unit 70 generates the first spectrum data S1 based on the table TL6 of the corrected first correspondence relationship. Accordingly, it is possible to acquire the first spectrum data S1 in which the deviation between the first correspondence relationship in the case where the electronic shutter function is used and the correspondence relationship in the case where the electronic shutter function is not used is corrected. Note that the analysis unit 70 may store the first correspondence relationship corresponding to the length of the charge discarding time DT as the table TL6. That is, the analysis unit 70 may generate the first spectrum data S1 based on the first correspondence relationship corresponding to at least one of the charge discarding time DT and the first exposure time ET1.

The analysis unit 70 may calculate a position on the wavelength axis of the first pixel column 51 corresponding to each wavelength using a mathematical expression instead of the table TL6 of the corrected first correspondence relationship. Such a calculation formula is represented by Formula 5.

$$W L ( t , λ ) = W {L}_{0} ( λ ) + \sum y \{ w ( y , t ) \times {WL}_{error} ( y , λ ) \} \qquad ( 5 )$$

In Formula 5, a weight of the first charge Q1 transferred from each of the first pixels 52 is modeled by w(y, t), where y is the position of each of the first pixels 52 in the vertical direction and t is the charge discarding time DT. In addition, in Formula 5, WLₑᵣᵣₒᵣ(y, λ) is a distortion amount of an image of each wavelength obtained by optical simulation, and WL₀(λ) is the reference x coordinate. As a result, the position on the wavelength axis of the first pixel column 51 can be calculated with high accuracy by calculating a deviation from the reference x coordinate WL₀(λ) from a multiplication result of the weight w(y, t) and the distortion amount WLₑᵣᵣₒᵣ(y, λ) for each of the first pixels 52.

In the above embodiment and the above modification, the case where the photodetector 4 sets the first exposure time ET1 to the time shorter than one frame time FT using the electronic shutter function has been described. Similarly, the photodetector 4 may set the second exposure time ET2 to a time shorter than the one frame time FT using the electronic shutter function. However, in that case, the photodetector 4 needs to set the first exposure time ET1 to be shorter than the second exposure time ET2. When the second exposure time ET2 is set using the electronic shutter function, the intensity of the second electric signal ES2 decreases corresponding to the charge discarding time DT. Therefore, the analysis unit 70 may store a fourth correction coefficient k4 corresponding to the charge discarding time DT and correct the second electric signal ES2 using the fourth correction coefficient k4 instead of the second correction coefficient k2. In addition, the second correspondence relationship in a case where the electronic shutter function is used changes from the second correspondence relationship in a case where the electronic shutter function is not used. Therefore, the second correspondence relationship corresponding to the length of the second exposure time ET2 may be measured in advance, and the analysis unit 70 may store a measured result as a corrected second correspondence relationship. Then, the analysis unit 70 may generate the second spectrum data S2 based on the corrected second correspondence relationship.

The analysis unit 70 may calculate a ratio between the third correction coefficient k3 and the fourth correction coefficient k4, and use the ratio between the third correction coefficient k3 and the fourth correction coefficient k4 to correct the intensity of the first spectrum data S1 or the intensity of the second spectrum data S2. For example, when the intensity I_{L}(λ) in the second spectrum data S2 is corrected, the corrected intensity I_{L}(λ)′ is expressed by Formula 6.

$$Intensity {I}_{L} ( λ ) ' = {I}_{L} ( λ ) / \{ {SR}_{calib} ( λ ) \times DRGain \times ( k 4 / k 3 ) \} \qquad ( 6 )$$

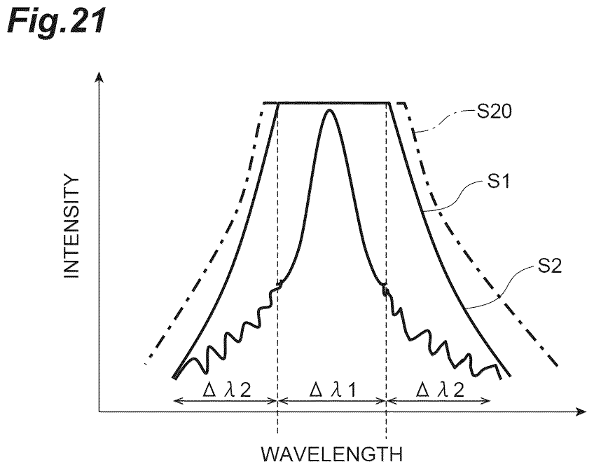

The photodetector 4 may have an anti-blooming function. When the second light receiving unit 6 is exposed for the second exposure time ET2, there is a case where the amount of the second charge Q2 accumulated in each of the second pixels 62 exceeds a specific amount. Accordingly, a phenomenon (blooming) in which an excess charge overflows into the adjacent second pixel 62 may occur. When the blooming occurs, the second spectrum data S2 becomes data S20 affected by the blooming as illustrated in FIG. 21. The analysis unit 70 cannot accurately couple the first spectrum data S1 and the data S20 affected by the blooming in generating the spectrum data S3 of the measurement target light L1. Therefore, for example, the photodetector 4 may prevent the blooming by disposing a drain in the second light receiving unit 6 and discarding the excess charge. In this case, the photodetector 4 may use the anti-blooming function for a charge amount of the second charge Q2 that is equal to or less than a value obtained by multiplying the specific amount by a maximum value (for example, 100 times) of DRGain in Formula 2.

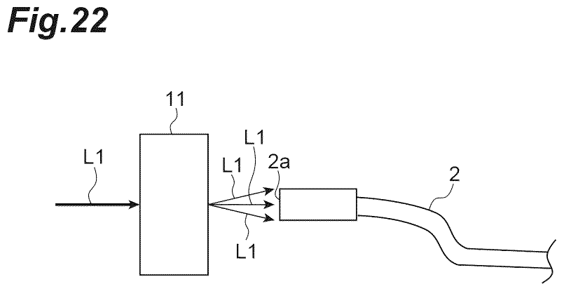

As illustrated in FIG. 22, the light diffusion unit 11 may be disposed at a preceding stage of the fiber bundle 2. The light diffusion unit 11 diffuses and guides the measurement target light L1 to the incident end face 2a. The light diffusion unit 11 is, for example, a diffusion plate. Since the measurement target light L1 diffused by the light diffusion unit 11 is incident on the incident end face 2a of the fiber bundle 2, the bias of the light intensity of the measurement target light L1 is suppressed on the incident end face 2a of the fiber bundle 2. In addition, the bias of the light intensity of the measurement target light L1 is also suppressed on the emitting end face 2b of the fiber bundle 2. Therefore, when focusing on the first pixel column 51 and the second pixel column 61 on which the optical image of the certain wavelength of the spectral image α is formed, it is possible to acquire the first spectrum data S1 and the second spectrum data S2 while suppressing the occurrence of the difference between the light intensity in the first pixel column 51 and the light intensity in the second pixel column 61.

The optical system 3 is not limited to the Dyson optical system, and may be another optical system (for example, a Czerny-Turner optical system). The diffraction grating 32 may be a transmissive diffraction grating. The photodetector 4 is not limited to the full-frame transfer type CCD image sensor, and may be another type of CCD image sensor such as an interline type or a frame transfer type. The photodetector 4 may perform vertical transfer and horizontal transfer by binning every n pixels (n is an integer of 2 to 127) instead of FVB. Alternatively, the photodetector 4 may vertically transfer the charge pixel by pixel. The computer device 20 may be a device incorporated in the spectroscope 10 instead of a personal computer or the like. The computer device 20 may store the correction coefficients instead of the storage unit 7. In this case, the computer device 20 may generate spectrum data of the measurement target light L1 after correcting data acquired from the photodetector 4. The emitting end face 2b of the fiber bundle 2 does not necessarily have an elongated shape. For example, the emitting end face 2b may have a circular shape. The fiber bundle 2 may include only one optical fiber. For example, the fiber bundle 2 may include any optical fiber among one first optical fiber 21, one second optical fiber 22, one third optical fiber 23, and one fourth optical fiber 24.

### REFERENCE SIGNS LIST

1 spectrometry device
2 fiber bundle
2a incident end face
2b emitting end face
3 optical system
4 photodetector
5 first light receiving unit
6 second light receiving unit
7 storage unit
8 control board
11 light diffusion unit
21 first optical fiber
22 second optical fiber
41 first vertical transfer unit
42 first horizontal transfer unit
43 first amplifier
44 second vertical transfer unit
45 second horizontal transfer unit
46 second amplifier
51 first pixel column
52 first pixel
61 second pixel column
62 second pixel
70 analysis unit
A wavelength axis
ES1 first electric signal
ES2 second electric signal
ET1 first exposure time
ET2 second exposure time
FT one frame time
k1 first correction coefficient
k2 second correction coefficient
k3 third correction coefficient
L0 stray light
L1 measurement target light
Q1 first charge
Q2 second charge
R1, R2 linearity characteristics
S1 first spectrum data
S2 second spectrum data
S3 spectrum data
α spectral image
Δλ1 saturation wavelength band
Δλ2 non-saturation wavelength band

1. A spectrometry device comprising:
an optical system configured to disperse measurement target light;
a photodetector configured to detect a spectral image of the measurement target light dispersed by the optical system; and
an analysis unit configured to generate spectrum data of the measurement target light, wherein
the photodetector includes:
a first light receiving unit including a plurality of first pixel columns arrayed in a horizontal direction parallel to a wavelength axis of the spectral image, each of the plurality of first pixel columns including a plurality of first pixels arrayed in a vertical direction perpendicular to the wavelength axis;
a second light receiving unit juxtaposing with the first light receiving unit in the vertical direction and includes a plurality of second pixel columns arrayed in the horizontal direction, each of the plurality of second pixel columns including a plurality of second pixels arrayed in the vertical direction;
a first vertical transfer unit configured to transfer a first charge accumulated in each of the plurality of first pixels by receiving the spectral image for a first exposure time in the first light receiving unit, for each of the plurality of first pixel columns in the vertical direction;
a first horizontal transfer unit configured to transfer the first charge transferred by the first vertical transfer unit in the horizontal direction;
a first amplifier configured to output a first electric signal corresponding to an amount of the first charge transferred by the first horizontal transfer unit;
a second vertical transfer unit configured to transfer a second charge accumulated in each of the plurality of second pixels by receiving the spectral image for a second exposure time longer than the first exposure time in the second light receiving unit, for each of the plurality of second pixel columns in the vertical direction;
a second horizontal transfer unit configured to transfer the second charge transferred by the second vertical transfer unit in the horizontal direction; and
a second amplifier configured to output a second electric signal corresponding to an amount of the second charge transferred by the second horizontal transfer unit, and
the analysis unit
stores a first correction coefficient for correcting the first electric signal to make a linearity characteristic of the first amplifier match with a reference linearity characteristic,
stores a second correction coefficient for correcting the second electric signal to make a linearity characteristic of the second amplifier match with the reference linearity characteristic,
corrects the first electric signal using the first correction coefficient,
corrects the second electric signal using the second correction coefficient,
generates first spectrum data based on the corrected first electric signal,
generates second spectrum data based on the corrected second electric signal, and
generates the spectrum data of the measurement target light based on the first spectrum data and the second spectrum data.

2. The spectrometry device according to claim 1, wherein
the analysis unit
generates the first spectrum data based on a first correspondence relationship between each of the plurality of first pixel columns and a wavelength on the wavelength axis, and
generates the second spectrum data based on a second correspondence relationship between each of the plurality of second pixel columns and the wavelength on the wavelength axis.

3. The spectrometry device according to claim 1, wherein the analysis unit corrects at least one of the first spectrum data and the second spectrum data based on a ratio between a representative value of an intensity of the first spectrum data and a representative value of an intensity of the second spectrum data.

4. The spectrometry device according to claim 1, wherein the analysis unit performs correction on the second spectrum data to remove stray light generated in the optical system.

5. The spectrometry device according to claim 1, further comprising a fiber bundle including a plurality of optical fibers guiding the measurement target light to the optical system and having an incident end face having a circular shape and an emitting end face having an elongated shape, wherein
the plurality of optical fibers include a plurality of first optical fibers disposed on one side with respect to a center of the emitting end face in the emitting end face and a plurality of second optical fibers disposed on another side with respect to the center of the emitting end face in the emitting end face, and
each of the plurality of first optical fibers and each of the plurality of second optical fibers are adjacent to each other in at least one of a circumferential direction and a radial direction in the incident end face.

6. The spectrometry device according to claim 1, further comprising:
a fiber bundle including a plurality of optical fibers guiding the measurement target light to the optical system; and
a light diffusion unit disposed at a preceding stage of the fiber bundle and configured to diffuse and guide the measurement target light to an incident end face of the fiber bundle.

7. The spectrometry device according to claim 1, wherein
the photodetector has an electronic shutter function that discharges the first charge accumulated in each of the plurality of first pixels over a predetermined time from a start of one frame time between a start of transfer of the first charge by the first vertical transfer unit to an end of transfer of the first charge by the first horizontal transfer unit, and the electronic shutter function that sets a time excluding the predetermined time in the one frame time as the first exposure time, and
the analysis unit
stores a third correction coefficient for correcting the first electric signal to make the linearity characteristic of the first amplifier match with the reference linearity characteristic in association with the predetermined time when the electronic shutter function is used, and
corrects the first electric signal using the third correction coefficient.

8. The spectrometry device according to claim 2, wherein
the photodetector has an electronic shutter function to discharge the first charge accumulated in each of the plurality of first pixels over a predetermined time from a start of one frame time between a start of transfer of the first charge by the first vertical transfer unit to an end of transfer of the first charge by the first horizontal transfer unit, and the electronic shutter function to set a time excluding the predetermined time in the one frame time as the first exposure time, and
the analysis unit generates the first spectrum data based on the first correspondence relationship corresponding to at least one of the predetermined time and the first exposure time.

9. The spectrometry device according to claim 1, wherein the photodetector has an electronic shutter function to discharge the first charge accumulated in each of the plurality of first pixels over a predetermined time from a start of one frame time between a start of transfer of the first charge by the first vertical transfer unit to an end of transfer of the first charge by the first horizontal transfer unit, and the electronic shutter function to sett a time excluding the predetermined time in the one frame time as the first exposure time.

10. The spectrometry device according to claim 1, wherein the analysis unit generates a first function of the first spectrum data and a second function of the second spectrum data when the first light receiving unit and the second light receiving unit are exposed for an identical exposure time, and corrects at least one of the first spectrum data and the second spectrum data based on a ratio between the first function and the second function.

11. The spectrometry device according to claim 1, wherein the analysis unit corrects at least one of the first spectrum data and the second spectrum data based on a ratio between the first exposure time and the second exposure time.

12. A spectrometry device comprising:
an optical system configured to disperse measurement target light;
a photodetector configured to detect a spectral image of the measurement target light dispersed by the optical system; and
a storage unit, wherein
the photodetector includes:
a first light receiving unit including a plurality of first pixel columns arrayed in a horizontal direction parallel to a wavelength axis of the spectral image, each of the plurality of first pixel columns including a plurality of first pixels arrayed in a vertical direction perpendicular to the wavelength axis;
a second light receiving unit juxtaposing with the first light receiving unit in the vertical direction and includes a plurality of second pixel columns arrayed in the horizontal direction, each of the plurality of second pixel columns including a plurality of second pixels arrayed in the vertical direction;
a first vertical transfer unit configured to transfer a first charge accumulated in each of the plurality of first pixels by receiving the spectral image for a first exposure time in the first light receiving unit, for each of the plurality of first pixel columns in the vertical direction;
a first horizontal transfer unit configured to transfer the first charge transferred by the first vertical transfer unit in the horizontal direction;
a first amplifier configured to output a first electric signal corresponding to an amount of the first charge transferred by the first horizontal transfer unit;
a second vertical transfer unit configured to transfer a second charge accumulated in each of the plurality of second pixels by receiving the spectral image for a second exposure time longer than the first exposure time in the second light receiving unit, for each of the plurality of second pixel columns in the vertical direction;
a second horizontal transfer unit configured to transfer the second charge transferred by the second vertical transfer unit in the horizontal direction; and
a second amplifier configured to output a second electric signal corresponding to an amount of the second charge transferred by the second horizontal transfer unit, and
the storage unit
stores a first correction coefficient for correcting the first electric signal to make a linearity characteristic of the first amplifier match with a reference linearity characteristic, and
stores a second correction coefficient for correcting the second electric signal to make a linearity characteristic of the second amplifier match with the reference linearity characteristic.

13. A spectrometry method using a spectrometry device, the spectrometry device including:
an optical system configured to disperse measurement target light;
a photodetector configured to detect a spectral image of the measurement target light dispersed by the optical system; and
an analysis unit configured to generate spectrum data of the measurement target light,
the photodetector including:
a first light receiving unit including a plurality of first pixel columns arrayed in a horizontal direction parallel to a wavelength axis of the spectral image, each of the plurality of first pixel columns including a plurality of first pixels arrayed in a vertical direction perpendicular to the wavelength axis;
a second light receiving unit juxtaposing with the first light receiving unit in the vertical direction and includes a plurality of second pixel columns arrayed in the horizontal direction, each of the plurality of second pixel columns including a plurality of second pixels arrayed in the vertical direction;
a first vertical transfer unit configured to transfer a first charge accumulated in each of the plurality of first pixels by receiving the spectral image for a first exposure time in the first light receiving unit, for each of the plurality of first pixel columns in the vertical direction;
a first horizontal transfer unit configured to transfer the first charge transferred by the first vertical transfer unit in the horizontal direction;
a first amplifier configured to output a first electric signal corresponding to an amount of the first charge transferred by the first horizontal transfer unit;
a second vertical transfer unit configured to transfer a second charge accumulated in each of the plurality of second pixels by receiving the spectral image for a second exposure time longer than the first exposure time in the second light receiving unit, for each of the plurality of second pixel columns in the vertical direction;
a second horizontal transfer unit configured to transfer the second charge transferred by the second vertical transfer unit in the horizontal direction; and
a second amplifier configured to output a second electric signal corresponding to an amount of the second charge transferred by the second horizontal transfer unit,
the spectrometry method comprising:
a step of correcting the first electric signal to make a linearity characteristic of the first amplifier match with a reference linearity characteristic and correcting the second electric signal to make a linearity characteristic of the second amplifier match with the reference linearity characteristic;
a step of generating first spectrum data based on the corrected first electric signal and generating second spectrum data based on the corrected second electric signal; and
a step of generating the spectrum data of the measurement target light based on the first spectrum data and the second spectrum data.
